(19) United States
(12) Patent Application Publication
(10) Pub. No.: US 2024/0328943 A1
(43) Pub. Date: Oct. 3, 2024

(54) SUBSTRATE FUNCTIONALIZED BY NAPHTHALENE-BASED SILICA NANOPARTICLES AS A SENSOR FOR DETECTING MERCURY IONS

(71) Applicant: KING FAHD UNIVERSITY OF PETROLEUM AND MINERALS, Dhahran (SA)

(72) Inventors: Muhammad MANSHA, Dhahran (SA); Shahid ALI, Dhahran (SA); Safyan Akram KHAN, Dhahran (SA); Nadeem BAIG, Dhahran (SA)

(73) Assignee: KING FAHD UNIVERSITY OF PETROLEUM AND MINERALS, Dhahran (SA)

(21) Appl. No.: 18/192,050

(22) Filed: Mar. 29, 2023

(51) Int. Cl. G01N 21/64; C07F 7/08

(52) U.S. Cl. CPC G01N 21/6428; C07F 7/0838; G01N 2021/6432

(57) ABSTRACT

A sensor for the detection of mercury ions that includes a substrate, a nanocomposite material at least partially covering a surface of the substrate. The nanocomposite material includes naphthalene-modified silica nanoparticles (NSPs) of Formula (I). The NSPs contains a naphthalene moiety, a maleic moiety, and an alkylamine functionalized silica nanoparticle, wherein the naphthalene moiety is covalently linked to the alkylamine functionalized silica nanoparticle via the maleic moiety. The nanocomposite material has a thermal stability up to a temperature of about 200° C. as determined by thermogravimetric analysis (TGA).

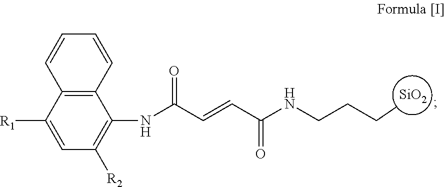

### STATEMENT REGARDING PRIOR DISCLOSURE BY THE INVENTORS

Aspects of this technology are described in “Naphthalene-based silica nanoparticles as a highly sensitive fluorescent chemosensor for mercury detection in real seawater,” Journal of Molecular Liquids, Volume 374, 121294, which is incorporated herein by reference in its entirety.

### BACKGROUND

### Technical Field

The present disclosure is directed to a sensor, particularly a sensor functionalized by naphthalene-based silica nanoparticles for detecting mercury ions.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Apart from daily life benefits, the contemporary and rapid developments in agricultural industries have harmed the global community by contaminating natural resources with hazardous and harmful chemicals [E. Gaggelli, H. Kozlowski, D. Valensin, G. Valensin, Copper Homeostasis and Neurodegenerative Disorders (Alzheimer's, Prion, and Parkinson's Diseases and Amyotrophic Lateral Sclerosis), Chem. Rev. 106 (2006) 1995-2044; D. T. Quang, J. S. Kim, Fluoro- and Chromogenic Chemodosimeters for Heavy Metal Ion Detection in Solution and Biospecimens, Chem. Rev. 110 (2010) 6280-6301; and M. Mansha, S. Akram Khan, M. A. Aziz, A. Zeeshan Khan, S. Ali, M. Khan, Optical Chemical Sensing of Iodide Ions: A Comprehensive Review for the Synthetic Strategies of Iodide Sensing Probes, Challenges, and Future Aspects, Chem. Rec. 22 (2022)]. The major water-borne pollutants such as pesticides, fertilizers, pharmaceuticals, volatile organic compounds, and heavy metal ions (Hg²⁺, Cd²⁺, Zn²⁺, Pb²⁺, etc.) have created an alarming situation for human health and living organisms. Among these pollutants, heavy metals possess detrimental effects on human organic tissues through air inhalation, food chain, and water circulation [G. Aragay, J. Pons, A. Merkogi, Recent Trends in Macro-, Micro-, and Nanomaterial-Based Tools and Strategies for Heavy-Metal Detection, Chem. Rev. 111 (2011) 3433-3458]. Mercury is the most prominent pollutant found in oceans, seas, rivers, and lakes. Specialists have estimated the amount of mercury in the seas is about 4000-10,000 tons annually, where 40% of that comes from natural sources and the other 60% from anthropogenic activities [M. F. Flores-Arce, Proceedings of the International Symposium on Selenium-Mercury Interactions, Biol. Trace Elem. Res. 119 (2007) 193-194].

Mercury exists in different oxidation states (Hg²⁺, Hg⁺, Hg⁰, [CH₃Hg]⁺) and is considered the leading cause of contamination in drinking water. These different forms of Hg are discharged into the environment through medical, industrial waste, and gold mining activities, thereby increasing the levels of mercury in nature [T. W. Clarkson, L. Magos, The toxicology of mercury and its chemical compounds, Crit. Rev. Toxicol. 36 (2006) 609-662; and J. F. Risher, R. A. Nickle, S. N. Amler, Elemental mercury poisoning in occupational and residential settings, Int. J. Hyg. Environ. Health. 206 (2003) 371-379]. Mercuric mercury (Hg²⁺) is the most stable form of mercury existing in nature [R. M. Gardner, J. F. Nyland, E. K. Silbergeld, Differential immunotoxic effects of inorganic and organic mercury species in vitro, Toxicol. Lett. 198 (2010) 182-190].

Even a small quantity of mercury that enters the human body can cause irreversible harm to vital organs and tissues, including the kidneys, liver, brain, and nervous/immune system, leading to the development of mobility and cognitive disorders [G. Aragay, J. Pons, A. Merkogi, Recent Trends in Macro-, Micro-, and Nanomaterial-Based Tools and Strategies for Heavy-Metal Detection, Chem. Rev. 111 (2011) 3433-3458]. According to the Environmental Protection Agency (EPA), the national primary drinking water regulations (NPDWR) enforce 2 ppb of Hg²⁺ as the maximum concentration permissible in drinking water.

Analytical techniques such as inductively coupled plasma mass spectrometry (ICP-MS), atomic absorption spectroscopy (AAS), plasma-atomic emission spectroscopy (AES), voltammetry, electrochemiluminescence (ECL), gas chromatography (GC), high-performance liquid chromatography (HPLC), titration and electrochemical process have been employed to monitor Hg²⁺ ions concentrations [R. Tel-Vered, J. S. Kahn, I. Willner, Layered Metal Nanoparticle Structures on Electrodes for Sensing, Switchable Controlled Uptake/Release, and Photo-electrochemical Applications, Small. 12 (2016) 51-75; V. Schroeder, S. Savagatrup, M. He, S. Lin, T. M. Swager, Carbon Nanotube Chemical Sensors, Chem. Rev. 119 (2019) 599-663; B.-P. Qi, L. Bao, Z.-L. Zhang, D.-W. Pang, Electrochemical Methods to Study Photoluminescent Carbon Nanodots: Preparation, Photoluminescence Mechanism and Sensing, ACS Appl. Mater. Interfaces. 8 (2016) 28372-28382; N. Wongkaew, M. Simsek, C. Griesche, A. J. Baeumner, Functional Nanomaterials and Nanostructures Enhancing Electrochemical Biosensors and Lab-on-a-Chip Performances: Recent Progress, Applications, and Future Perspective, Chem. Rev. 119 (2019) 120-194; and S. Ali, M. Mansha, N. Baig, S. A. Khan, Recent Trends and Future Perspectives of Emergent Analytical Techniques for Mercury Sensing in Aquatic Environments, Chem. Rec. 22 (2022) e202100327]. The conventional techniques for Hg²⁺ detection have certain limitations such as high cost, complex procedures, and labor-intensive processes. These factors restrict their usage in remote sensing applications. Therefore, there is a pressing need to develop cost-effective materials that possess high sensitivity, selectivity, good biocompatibility, and exceptional performance to detect Hg²⁺ ions efficiently. In addition, these materials should be capable of detecting Hg²⁺ ions at levels as low as parts per billion (ppb) level in the environmental samples [D. T. Quang, J. S. Kim, Fluoro- and Chromogenic Chemodosimeters for Heavy Metal Ion Detection in Solution and Biospecimens, Chem. Rev. 110 (2010) 6280-6301; and E. M. Nolan, S. J. Lippard, Tools and Tactics for the Optical Detection of Mercuric Ion, Chem. Rev. 108 (2008) 3443-3480]. Fluorescence/colorimetric-based optical sensing methods are getting attention for mercury detection. These fluorescent-based materials offer several advantages, such as low limit of detection (LOD), rapid analysis, high sensitivity, and selectivity for environmental pollutant investigations [E. M. Nolan, S. J. Lippard, Tools and Tactics for the Optical Detection of Mercuric Ion, Chem. Rev. 108 (2008) 3443-3480]. A pyrenyl amide-based chemosensor for Hg²⁺ ions detection in an aqueous environment and found LOD about 1.6 μM has been described [J. S. Kim, M. G. Choi, K. C. Song, K. T. No, S. Ahn, S.-K. Chang, Ratiometric Determination of Hg²⁺ Ions Based on Simple Molecular Motifs of Pyrene and Dioxaoctanediamide, Org. Lett. 9 (2007) 1129-1132].

Feng et al. [D. Feng, P. Li, X. Tan, Y. Wu, F. Wei, F. Du, C. Ai, Y. Luo, Q. Chen, H. Han, Electrochemiluminescence aptasensor for multiple determination of Hg²⁺ and Pb²⁺ ions by using the MIL-53(Al)@CdTe-PEI modified electrode, Anal. Chim. Acta. 1100 (2020) 232-239] fabricated an aptasensor of MIL-53(Al)@CdTe-polyethyleneimine which can be used for electrochemiluminescence (ECL) sensing of Hg²⁺ and Pb²⁺ ions at the same single interface. To further improve the LOD, Babamiri et al. [B. Babamiri, A. Salimi, R. Hallaj, Switchable electrochemiluminescence aptasensor coupled with resonance energy transfer for selective attomolar detection of Hg²⁺ via CdTe@CdS/dendrimer probe and Au nanoparticle quencher, Biosens. Bioelectron. 102 (2018) 328-335] used the ECL resonance energy transfer mechanism for Hg²⁺ ions sensing. In another study, Kumar et al. [D. Nanda Kumar, N. Chandrasekaran, A. Mukherjee, Horseradish peroxidase-mediated in situ synthesis of silver nanoparticles: application for sensing of mercury, New J. Chem. 42 (2018) 13763-13769] investigated the spectrophotometric detection of Hg²⁺. The addition of Hg²⁺ ions reduced the enzyme activity and caused Ag-NPs accumulation, [N. Zhang, J. Xu, C. Xue, Core-shell structured mesoporous silica nanoparticles equipped with pyrene-based chemosensor: Synthesis, characterization, and sensing activity towards Hg(II), J. Lumin. 131 (2011) 2021-2025] prepared Py-SiO₂ core-shell NPs by making a receptor of hydrazone moiety for Hg²⁺ ions.

Based on recent studies, the development of fluorescence sensors for mercury detection at trace levels in an aqueous phase is still considered a challenge. Therefore, there is a need to develop extremely sensitive/selective, easy-to-synthesize, and portable fluorescent sensors to analyze mercury in real sample matrices.

In view of the forgoing, one objective of the present disclosure is to describe a sensor for the detection of mercury ion. A further objective of the present disclosure is to describe a method of making the sensor. A third objective of the present disclosure is to describe a mercury ion detection method.

### SUMMARY

In an exemplary embodiment, a sensor for the detection of mercury ion is described. The sensor includes a substrate, and a nanocomposite material at least partially covering a surface of the substrate. In some embodiments, the nanocomposite material includes naphthalene-modified silica nanoparticles (NSPs) of formula (I)

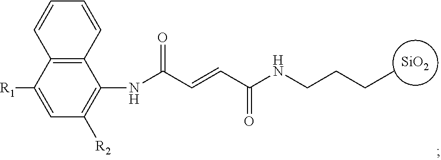

In some embodiments, the NSPs contains a naphthalene moiety, a maleic moiety, and an alkylamine functionalized silica nanoparticle. In some embodiments, the naphthalene moiety is covalently linked to the alkylamine functionalized silica nanoparticle via the maleic moiety. In some embodiments, the nanocomposite material has a thermal stability up to a temperature of about 200° C. as determined by thermogravimetric analysis (TGA).

In some embodiments, the substrate includes a silicon portion, and a glass portion.

In some embodiments, the substrate is glass. In some embodiments, the glass is at least one selected from the group consisting of a fluorine-doped tin oxide (FTO) glass, a tin-doped indium oxide (ITO) glass, an aluminum doped zinc oxide (AZO) glass, a niobium doped titanium dioxide (NTO) glass, an indium doped cadmium oxide (ICO) glass, an indium doped zinc oxide (IZO) glass, a fluorine-doped zinc oxide (FZO) glass, a gallium doped zinc oxide (GZO) glass, an antimony doped tin oxide (ATO) glass, a phosphorus-doped tin oxide (PTO) glass, a zinc antimonate glass, a zinc oxide glass, a ruthenium oxide glass, a rhenium oxide glass, a silver oxide glass, and a nickel oxide glass.

In some embodiments, R₁, and R₂ are each independently selected from the group consisting of hydrogen, an optionally substituted alkyl, an optionally substituted cycloalkyl, an optionally substituted alkoxy, a hydroxyl group, a halogen group, a nitro group, a sulfonic acid group, a sulfonate group, and a cyano group.

In some embodiments, the naphthalene-modified silica nanoparticles have a formula (II)

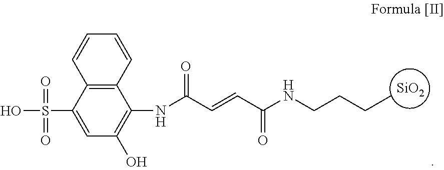

In some embodiments, the naphthalene modified silica nanoparticles are uniformly disposed on the surface of the substrate.

In some embodiments, the naphthalene modified silica nanoparticles are in the form of agglomerates having an average particle size of 30 to 90 nanometers (nm).

In some embodiments, the sensor has a zeta potential value of −60 to −20 millivolts (mV).

In some embodiments, the sensor has a maximum fluorescence at the excitation wavelength of 230 to 240 nm.

In some embodiments, the sensor has a capability to detect a ppb concentration level of mercury ions (Hg²⁺) in the presence of one or more interfering cations selected from the group consisting of La³⁺, Y2+, Mn²⁺, Sr³⁺, Ba²⁺, Ce³⁺, Mo³⁺, Pb²⁺, Ni²⁺, Co²⁺, Ag⁺, Cd²⁺, and Cr²⁺.

In some embodiments, a method of preparing the nanocomposite material is described. The nanocomposite material is prepared by mixing a naphthalene compound, an alkyl amine, and a solvent to form a reaction mixture; portion-wise adding maleic anhydride into the reaction mixture and mixing to form a first intermediate in a first mixture; mixing at least one coupling agent with the first mixture containing the first intermediate to generate a second intermediate in a second mixture; mixing a silane agent and a base with the second mixture containing the second intermediate to generate a crude product in a third mixture; and dialyzing the third mixture containing the crude product, evaporating, and drying to form the nanocomposite material.

In some embodiments, the naphthalene compound has a formula (III)

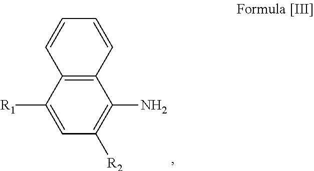

where R₁, and R₂ are each independently selected from the group consisting of hydrogen, an optionally substituted alkyl, an optionally substituted cycloalkyl, an optionally substituted alkoxy, a hydroxyl group, a halogen group, a nitro group, a sulfonic acid group, a sulfonate group, and a cyano group.

In some embodiments, the naphthalene compound is 4-amino-3-hydroxy-1-naphthalene sulfonic acid.

In some embodiments, the alkyl amine comprises alkyl groups having 3 to 10 carbon atoms.

In some embodiments, the first intermediate has a formula (IV)

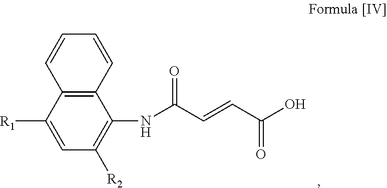

wherein R₁, and R₂ are each independently selected from the group consisting of hydrogen, an optionally substituted alkyl, an optionally substituted cycloalkyl, an optionally substituted alkoxy, a hydroxyl group, a halogen group, a nitro group, a sulfonic acid group, a sulfonate group, and a cyano group.

In some embodiments, the second intermediate has a formula (V)

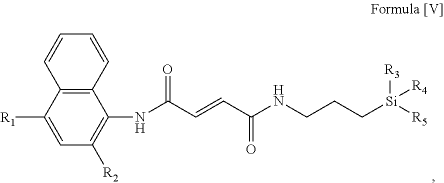

wherein R₁, R₂, R₃, R₄, and R₅ are each independently selected from the group consisting of hydrogen, an optionally substituted alkyl, an optionally substituted cycloalkyl, an optionally substituted alkoxy, a hydroxyl group, a halogen group, a nitro group, a sulfonic acid group, a sulfonate group, and a cyano group.

In some embodiments, the method further includes mixing the nanocomposite material and a solvent to form a fourth mixture; and drop casting the fourth mixture onto a surface of the substrate and drying to form the sensor having a layer of the nanocomposite material at least partially covered on the surface of the transparent substrate.

In an exemplary embodiment, a mercury ion detection method is described. The method includes contacting an aqueous composition containing mercury ions with the sensor to adsorb the mercury ions on the naphthalene modified silica nanoparticles and generate a signal corresponding to a fluorescence intensity by the sensor.

In some embodiments, the sensor achieves maximum fluorescence intensity when a mole ratio of naphthalene modified silica nanoparticles present on the sensor to mercury ions present in the aqueous composition is in a range of 1:5 to 1:1.

In some embodiments, the sensor has a detection limit of 1 parts per billion (ppb) by weight for mercury ions, and a linearity range of 0.1 ppb to 10 parts per million (ppm) by weight.

The foregoing general description of the illustrative present disclosure and the following The detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flow chart depicting a method of making naphthalene-based silica nanoparticles (NSPs), according to certain embodiments;

FIG. 2A depicts a synthetic scheme of making the NSPs, according to certain embodiments;

FIG. 2B is a schematic illustration depicting a method of purifying crude NSPs to form the NSPs, according to certain embodiments;

FIG. 3 depicts a ¹H-NMR spectrum of the NSPs, according to certain embodiments;

FIG. 4 depicts a Fourier Transform Infrared Spectra (FTIR) of an intermediate I, intermediate II, and the NSPs, according to certain embodiments;

FIG. 5 depicts a thermogravimetric analysis (TGA) curve of the NSPs, according to certain embodiments;

FIG. 6 depicts a surface charge and zeta potential measurements of the NSPs in the aqueous environment, according to certain embodiments;

FIG. 7 depicts the X-ray diffraction (XRD) patterns of unmodified silica NPs and the NSPs, according to certain embodiments;

FIG. 8A depicts a high-resolution field emission scanning electron microscope (FESEM) image of unmodified silica nanoparticles NPs, according to certain embodiments;

FIG. 8B depicts a high-resolution FESEM image of the NSPs, according to certain embodiments;

FIG. 9 is a plot depicting UV-Visible absorption spectrum of NSPs exhibiting maxima at 235, 290, and 336 nm, according to certain embodiments;

FIG. 10 is a plot of fluorescence intensity versus excitation wavelength to determine the maximum fluorescence emission intensity, according to certain embodiments;

FIG. 11 is a plot to determine the effect of the concentration of the NSPs on fluorescence emission intensity, according to certain embodiments;

FIG. 12A is a pictogram of the NSPs under normal light dispersed in de-ionized water (DW), according to certain embodiments;

FIG. 12B is a pictogram of the NSPs under normal light dispersed in de-ionized water and Hg²⁺ solution, according to certain embodiments;

FIG. 12C is a pictogram of the NSPs under UV light dispersed in de-ionized water, according to certain embodiments;

FIG. 12D is a pictogram of the NSPs under UV light dispersed in de-ionized water and Hg²⁺ solution, according to certain embodiments;

FIG. 13 is photoluminescence (PL) emission spectra of the NSPs (20 ppm) before and after exposure to Hg²⁺ ions at various concentration ranges (0-50 ppm) at λₑₓ=235 nm, according to certain embodiments;

FIG. 14 is a Stern-Volmer plot to measure the equilibrium constant (Kₛᵥ) for the NSPs interacting with Hg²⁺ ions (Kₛᵥ=0.409×10⁶ M⁻¹), according to certain embodiments;

FIG. 15 depicts the selectivity of the NSPs (20 ppm) against Hg²⁺ ions (10 ppm, 0.05 mM) upon the addition of cations (0.05 mM) such as La³⁺, Y2+Mn²⁺, Sr³⁺, Ba²⁺, Ce³⁺, Mo³⁺, Pb²⁺, Ni²⁺, Co²⁺, Ag⁺, Cd²⁺, and Cr²⁺, according to certain embodiments;

FIG. 16 depicts PL emission spectra of real seawater (SW) samples demonstrating the fluorescence quenching of NSPs (20 ppm) upon addition of Hg²⁺ ions (10 ppm, 0.05 mM); Xₑₓ=235 nm, according to certain embodiments;

FIG. 17 is a plot depicting the selectivity of the NSPs against Hg²⁺ ions upon the addition of major cations of seawater such as Na⁺, K⁺, Ca²⁺, and Mg²⁺ ions, according to certain embodiments;

FIG. 18 is a Job's plot to attain the binding stoichiometry of the NSPs with Hg⁺² ions, according to certain embodiments; and

FIG. 19 is a schematic illustration depicting a plausible mechanism for attaching mercury (Hg²⁺) ions with the NSPs, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “sensor” refers to that which detects the presence, such as measuring the concentration, of an analyte, such as Hg²⁺ ions, by oxidizing or reducing the analyte at an electrode and detecting, such as measuring, the resulting current. The resulting current need not necessarily be measured as a current but may, for example, be measured as a voltage drop across a resistor.

As used herein, “limit of detection (LOD)” is the smallest concentration of an analyte in a test sample that can be easily distinguished from zero.

As used herein, the term “working electrode” refers to the electrode, the sensor on which the reaction of interest occurs.

As used herein, “linear dynamic range (LDR)” is the range of concentrations where the signals are directly proportional to the analyte concentration in the sample.

As used herein, “selectivity” is the quality of the electrochemical response that can be achieved without interference for any other substance.

As used herein, “sensitivity” is the change in the electrochemical response with regard to a change in the concentration of the analyte.

As used herein, “alkyl” is defined broadly as saturated or unsaturated, branched, or linear non-aromatic hydrocarbons, preferably having 1 to 8 carbon atoms. They may be optionally substituted by non-hydrocarbons.

As used herein, “cycloalkyls” are cyclic alkyls, preferably having 1 to 20 or 5 to 20 carbon atoms, respectively.

As used herein, “alkoxy” refers to an alkyl group, prefearbly having 1 to 8 carbon atoms, which is singularly bonded to oxygen Mercury is one of the most harmful contaminants threatening human lives and the aquatic environment. Naphthalene and its derivatives have fluorescence properties that can be exploited for mercury (Hga+) sensing applications. Aspects of the present disclosure are directed to synthesizing covalently attached naphthalene with silica nanoparticles (NSPs) using a one-pot multiple steps synthesis approach.

A sensor for the detection of mercury ions is described. The sensor includes a substrate onto which is disposed a layer of nanocomposite material covering, at least partially, a surface of the substrate. In some embodiments, the substrate includes a silicon portion and a glass portion.

In some embodiments, the silicon portion and the glass portion in the substrate may be appropriately selected depending on the intended purpose. In some embodiments, the silicon portion in the substrate may include silicon in the form of single-crystal silicon, amorphous silicon, and polysilicon. Further, the glass portion of the substrate is selected from the group consisting of fluorine-doped tin oxide (FTO) glass, a tin-doped indium oxide (ITO) glass, an aluminum-doped zinc oxide (AZO) glass, a niobium-doped titanium dioxide (NTO) glass, an indium-doped cadmium oxide (ICO) glass, an indium-doped zinc oxide (IZO) glass, a fluorine-doped zinc oxide (FZO) glass, a gallium-doped zinc oxide (GZO) glass, an antimony-doped tin oxide (ATO) glass, a phosphorus-doped tin oxide (PTO) glass, a zinc antimonate glass, a zinc oxide glass, a ruthenium oxide glass, a rhenium oxide glass, a silver oxide glass, and a nickel oxide glass. In some preferred embodiments, an area ratio of the silicon portion and the glass portion of the substate may be in a range of 100:1 to 1:100, preferably 1:80 to 80:1, preferably 1:60 to 60:1, preferably 1:40 to 40:1, preferably 1:20 to 20:1, preferably 1:5 to 5:1, or even more preferably about 1:1. Other ranges are also possible.

In some embodiments, the substrate may have a thickness of less than or equal to about 3 mm, for example, preferably ranging from about 0.1 mm to about 2.5 mm, preferably from about 0.3 mm to about 2 mm, preferably from about 0.7 mm to about 1.5 mm, or more preferably from about 1 mm to about 1.2 mm, including all ranges and subranges therebetween. In some preferred embodiments, the substrate may have a thickness of 0.5 mm to 3 mm from the viewpoint of easiness in handling. Other ranges are also possible.

The sensor further includes the nanocomposite material coated at least partially on the surface of the substrate. The deposition of the nanocomposite material on the substrate may be brought about by any of the methods conventionally known in the art, for example, lithographic techniques and drop casting technique. The nanocomposite material includes naphthalene-modified silica particles (NSPs). In an embodiment, the NSPs is a compound of formula (I)

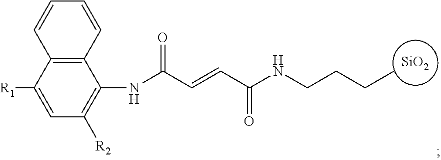

where R₁, and R₂ are each independently selected from the group consisting of hydrogen, an optionally substituted alkyl, an optionally substituted cycloalkyl, an optionally substituted alkoxy, a hydroxyl group, a halogen group, a nitro group, a sulfonic acid group, a sulfonate group, and a cyano group. In some embodiments, R₁ is a sulfonic acid group. In some embodiments, R₂ is a hydroxyl group.

In some embodiments, the NSPs contains a naphthalene moiety, a maleic moiety, and an alkylamine functionalized silica nanoparticle. In some further embodiments, an amine group of the naphthalene moiety is bonded to a first carbonyl group of the maleic moiety. In some further embodiments, an amine group of the alkylamine functionalized silica nanoparticle is bonded to a second carbonyl group of the maleic moiety. In some preferred embodiments, the naphthalene moiety is covalently linked to the alkylamine functionalized silica nanoparticle via the maleic moiety.

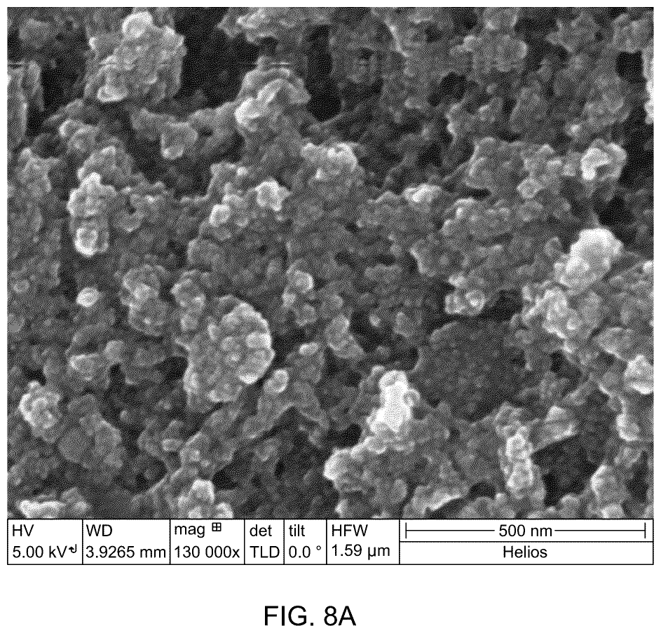

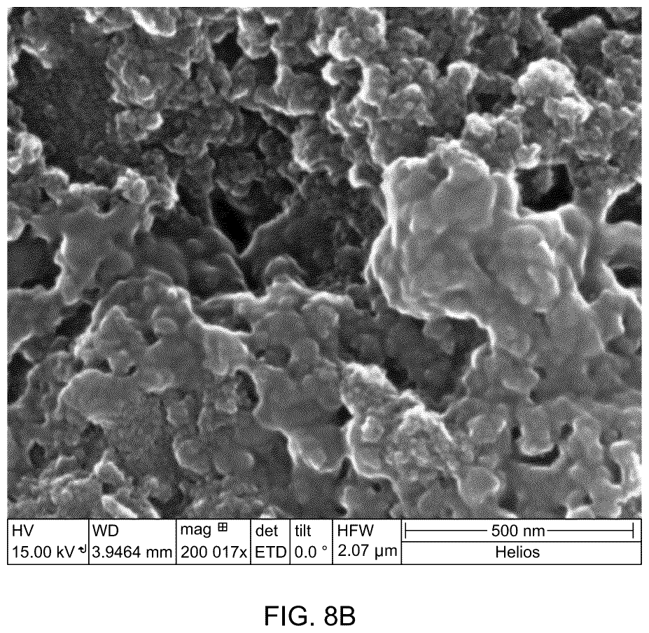

In some embodiments, the silica nanoparticles may be of any shape such as spheres, nanotubes, nanowires, tetragons, hexagons, and cylinders, as depicted in FIG. 8A. In some further embodiments, the silica nanoparticles are nanospheres in the form of aggregates. In some preferred embodiments, the silica nanoparticles have an average particle size in a range of 5 to 50 nanometers (nm), preferably 10 to 45 nm, preferably 15 to 40 nm, preferably 20 to 35 nm, or even more preferably 25 to 30 nm. Other ranges are also possible.

In some embodiments, the naphthalene moiety is present in the naphthalene-modified silica particles (NSPs) at a concentration of 0.5 to 60 wt. % based on a total weight of the NSPs, preferably 5 to 55 wt. %, preferably 15 to 50 wt. %, preferably 20 to 45 wt. %, preferably 25 to 40 wt. %, or even more preferably 30 to 35 wt. % based on the total weight of the NSPs. In some further embodiments, the alkylamine functionalized silica nanoparticle is present in the naphthalene-modified silica particles (NSPs) at a concentration of 10 to 95 wt. % based on a total weight of the NSPs, preferably 20 to 80 wt. %, preferably 30 to 70 wt. %, preferably 40 to 60 wt. %, or even more preferably 50 to 55 wt. % based on the total weight of the NSPs. In some embodiments, the maleic moiety is present in the naphthalene-modified silica particles (NSPs) at a concentration of 0.05 to 20 wt. % based on a total weight of the NSPs, preferably 1 to 15 wt. %, preferably 5 to 10 wt. %, or even more preferably about 10 wt. % based on the total weight of the NSPs. Other ranges are also possible.

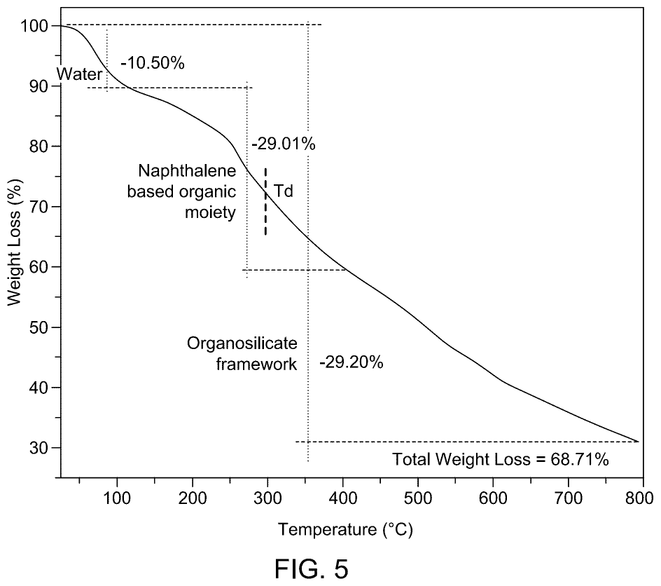

FIG. 5 illustrates a thermogravimetric analysis (TGA) curve of the naphthalene modified silica nanoparticles. The thermogravimetric analysis may be performed on a TGA 1 STAR System (Mettler Toledo, USA) under Argon atmosphere at a flow rate of 10 to 30 mL min⁻¹, preferably about 20 mL min⁻¹ from ambient temperature to about 1000° C., preferably about 800° C. at a rate of 0.1 to 30° C. min⁻¹, preferably 1 to 25 10° C. min⁻¹, preferably 5 to 20 10° C. min⁻¹, preferably 10 to 15° C. min⁻¹, or even more preferably about 10° C. min⁻¹. Other ranges are also possible. In some embodiments, the nanocomposite material has a first weight loss up to 15% by weight of the nanocomposite a temperature of 40 to 160° C., preferably 80 to 120° C., or even more preferably about 120° C., as depicted in FIG. 5. In some further embodiments, the nanocomposite material has a second weight loss of 10 to 30% by weight of the nanocomposite at a temperature of 120 to 400° C., preferably 160 to 300° C., or even more preferably about 200° C., as depicted in FIG. 5. In some further preferred embodiments, the nanocomposite material has a third weight loss of 30 to 75% by weight of the nanocomposite at a temperature of 400 to 800° C., preferably 450 to 600° C., or even more preferably about 500° C., as depicted in FIG. 5. Other ranges are also possible.

In some embodiments, the naphthalene modified silica nanoparticles are in the form of agglomerates, as depicted in FIG. 8B. In some embodiments, the naphthalene modified silica nanoparticles may exist in any other morphological form such as spheres, nanotubes, nanowires, tetragons, hexagons, and cylinders. In some further embodiments, the naphthalene modified silica nanoparticles may have an average particle size of 20 to 120 nm, preferably between 30 to 100 nm, preferably 40 to 90 nm, and most preferably between 50 to 80 nm. Other ranges are also possible. In some preferred embodiments, the naphthalene modified silica nanoparticles may accumulate on the surface of the substrate to form micro-sized aggregates in any irregular shape, as depicted in FIG. 8B.

In some embodiments, the naphthalene modified silica nanoparticles are uniformly disposed on the surface of the substrate. It is preferred that the naphthalene modified silica nanoparticles forms a uniform layer that completely covers the surface of the substrate. In some embodiments, at least 50% of the surface of the substrate is covered by the naphthalene modified silica nanoparticles based on a total surface area of the substrate, preferably at least 70%, preferably at least 90%, or even more preferably at least 99%, based on the total surface area of the substrate. In another embodiment, only one side of the substrate is covered with the naphthalene modified silica nanoparticles.

The NSPs were characterized by ¹H-NMR, FTIR, TGA, FESEM, XRD, and UV-Vis spectroscopy. The fluorescent properties were analyzed in de-ionized water under normal and UV-light illumination. Finally, the synthesized NSPs were investigated as a chemosensor for Hg²⁺ ions detection in real seawater samples via PL spectroscopy. The results indicate that the fluorescence properties of NSPs (20 ppm) were quenched upon Hg²⁺ addition in the range from 0-50 ppm. The experimental studies demonstrated that NSPs acted as a potential host for Hg²⁺ ions compared to other interfering ions in the seawater sample. The NSPs chemosensor provides a linearity range (0.5 ppb-5.0 ppm) and limit of detection LOD (1 ppb; 5 nM), which is below the values suggested by US EPA drinking water safety regulations.

The crystalline structures of the silica nanoparticles, and the naphthalene modified silica nanoparticles may be characterized by X-ray diffraction (XRD), respectively. In some embodiments, the XRD patterns are collected in a Rigaku diffractometer equipped with a Cu-Kα radiation source (λ=0.15416 nm) for a 20 range extending between 5 and 90°, preferably 15 and 80°, further preferably 30 and 60° at an angular rate of 0.005 to 0.04° s⁻¹, preferably 0.01 to 0.03° s⁻¹, or even preferably 0.02° s⁻¹.

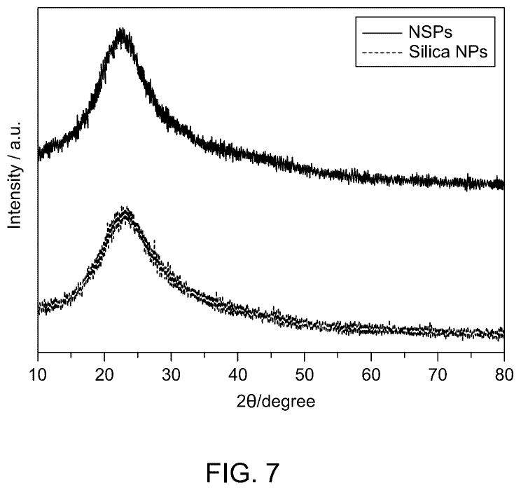

An X-ray diffraction (XRD) pattern of the silica nanoparticles, and the naphthalene modified silica nanoparticles is illustrated in FIG. 7. In some embodiments, the silica nanoparticles has an intense peak with a 2 theta (0) value in a range of 20 to 30° in the XRD spectrum, preferably about 23°, as illustrated in FIG. 7 (JCPDS No. 00-001-0649) [Y. Wang, B. Li, L. Zhang, L. Liu, Q. Zuo, P. Li, A highly selective regenerable optical sensor for detection of mercury(ii) ion in water using organic-inorganic hybrid nanomaterials containing pyrene, New J. Chem. 34 (2010) 1946; and A. U. Rehman, S. A. Khan, S. Ali, M. F. Nazar, A. Shah, A. Rahman Khan, A. M. Khan, Counterion engineered surfactants for the novel synthesis of colloidal metal and bimetal oxide/SiO₂ materials with catalytic applications, Colloids Surfaces A Physicochem. Eng. Asp. 571 (2019) 80-85, each incorporated herein by reference in their entirety]. In some further embodiments, the naphthalene modified silica nanoparticles has an intense peak with a 2 theta (0) value in a range of 20 to 30° in the XRD spectrum, preferably about 22.5°.

The photoluminescence (PL) spectra of the naphthalene modified silica nanoparticles may be collected from the spectrofluorometer (FP-8500, JASCO). A sample containing the NSPs in mercury solutions may be exposed to an excitation wavelength of 200 to 800 nm, preferably 300 to 600 nm, or more preferably about 235 nm, and a bandwidth of 1 to 10 nm, preferably about 5 nm.

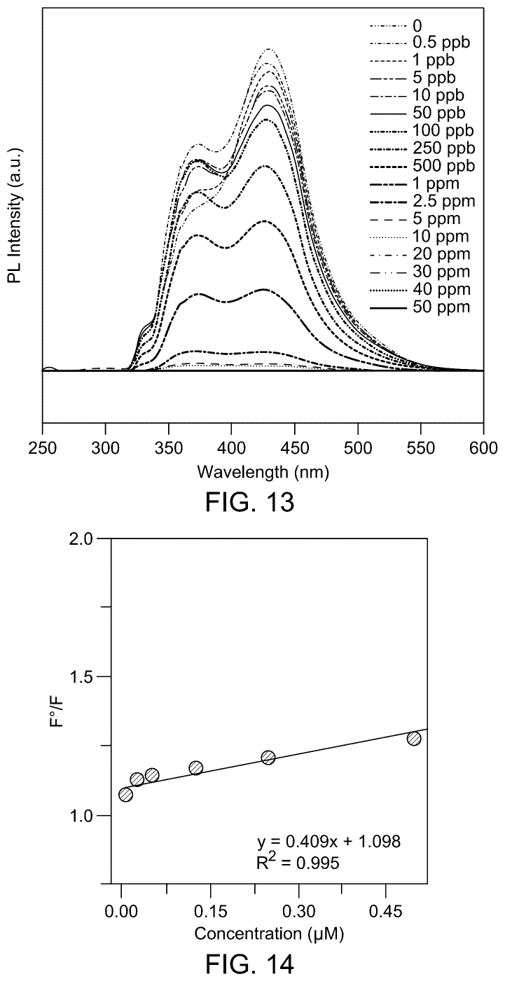

FIG. 13 illustrates a photoluminescence (PL) emission spectra of the NSPs (20 ppm) before and after exposure to Hg²⁺ ions. at various concentration ranges 0 to 50 ppm at λₑₓ=235 nm. In some embodiments, Hg²⁺ ions has a concentration in a ranges 0 to 50 ppm at λₑₓ=235 nm. In some further embodiments, the NSPs have a first peak in a wavelength range of 300 to 370 nm, preferably about 365 nm, and a second peak in a wavelength range of 420 to 470 nm, or even more preferably about 440 nm.

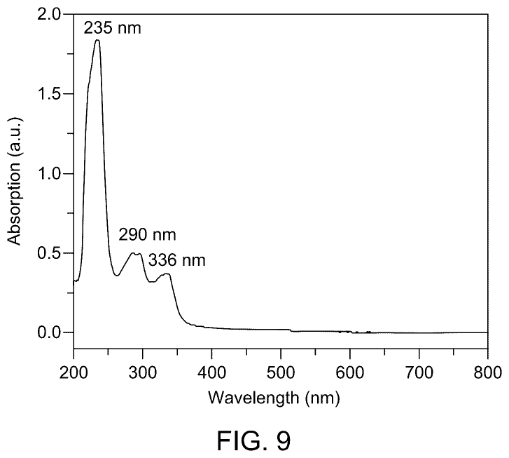

FIG. 9 illustrates UV-Visible absorption spectrum of NSPs. In some embodiments, the NSPs has a first intense absorption peak in a range of 210 to 255 nm, preferably about 235 nm; a second intense absorption peak in a range of 270 to 310 nm, preferably about 290 nm; and a third intense absorption peak in a range of 310 to 350 nm, preferably about 336 nm, as depicted in FIG. 9. Other ranges are also possible.

It is desirable that the sensor of the present disclosure is stable in aqueous environments—for real-time detection of mercury ions in real water samples, for example, seawater, freshwater bodies, lakes, and the like. To achieve this objective, optionally, hydrophilic functionalities, such as SO₃H, and hydroxy groups, can be incorporated along with the naphthalene moiety to design a water-stable sensor. In a preferred embodiment, the NSPs have a formula (II)

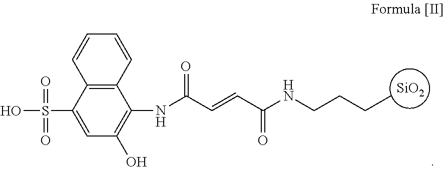

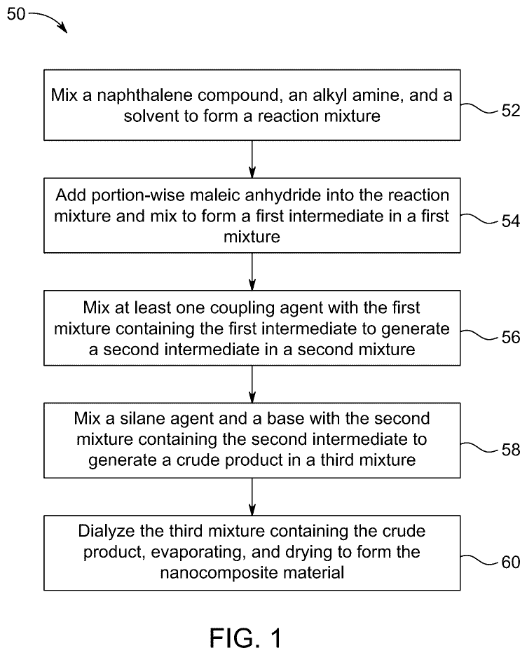

Referring to FIG. 1, a method of preparing the nanocomposite material is described. The order in which the method 50 described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing a naphthalene compound, an alkyl amine, and a solvent to form a reaction mixture. The naphthalene compound has a formula (III)

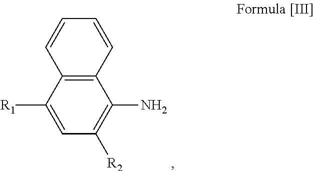

where R₁, and R₂ are each independently selected from the group consisting of hydrogen, an optionally substituted alkyl, an optionally substituted cycloalkyl, an optionally substituted alkoxy, a hydroxyl group, a halogen group, a nitro group, a sulfonic acid group, a sulfonate group, and a cyano group. In a preferred embodiment, the naphthalene compound is 4-amino-3-hydroxy-1-naphthalene sulfonic acid. The alkyl amine comprises alkyl groups having 3 to 10 carbon atoms. In an embodiment, the alkyl amine is N,N-diisopropylethylamine. In some embodiments, the molar ratio of the naphthalene compound to the alkyl amine is in a ratio range of 1:1 to 1:5, preferably 1:1 to 1:3, and more preferably about 1:2. Other ranges are also possible.

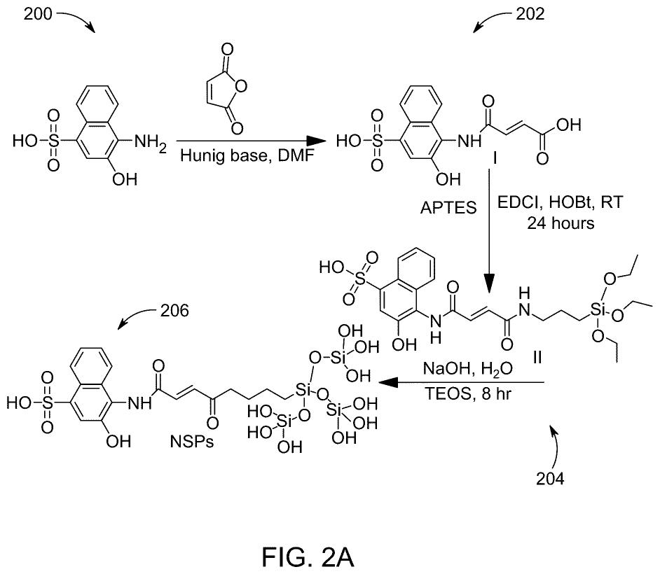

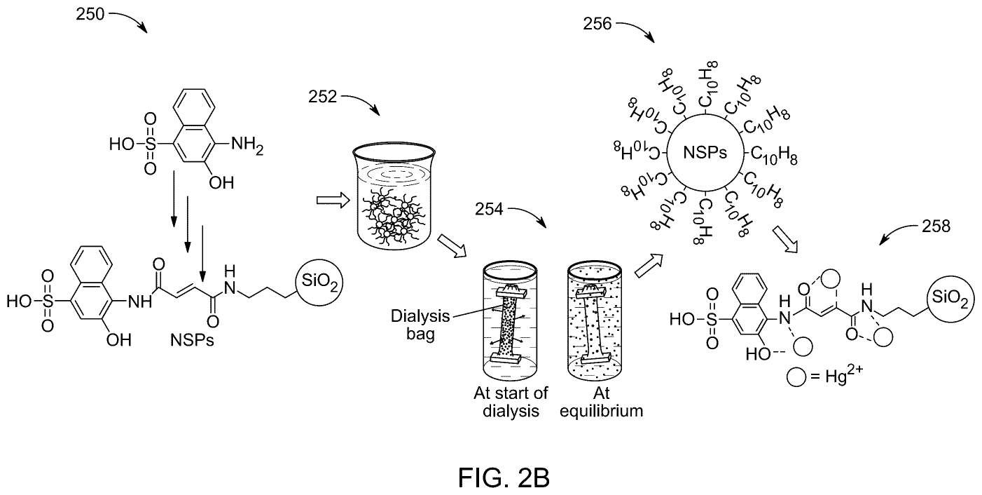

The solvent may be one or more of acetonitrile, methanol, methyl ethyl ketone (MEK), 1 butanol, t-butanol, tert-butyl methyl ether, triethylamine, toluene, dimethyl formamide (DMF), dimethyl sulfoxide (DMSO). In a preferred embodiment, the solvent is dimethyl formamide (DMF). FIG. 2A depicts a synthetic scheme of making NSPs. In some embodiments, the reaction between the naphthalene compound (200), i.e., the 4-amino-3-hydroxy-1-naphthalene sulfonic acid with the alkyl amine, i.e., N,N-diisopropylethylamine in the presence of a solvent (DMF) is carried out at room temperature in a range of 20-37° C., for a period of 10-30 minutes, preferably 12-20 minutes, more preferably for about 15 minutes to yield the reaction mixture.

At step 54, the method 50 includes portion-wise adding maleic anhydride into the reaction mixture and mixing to form a first intermediate (202) in a first mixture as depicted in FIG. 2A. The first intermediate has a formula (IV)

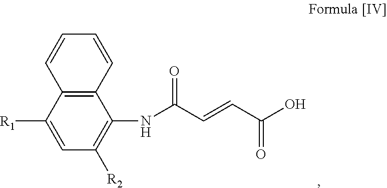

where R₁, and R₂ are each independently selected from the group consisting of hydrogen, an optionally substituted alkyl, an optionally substituted cycloalkyl, an optionally substituted alkoxy, a hydroxyl group, a halogen group, a nitro group, a sulfonic acid group, a sulfonate group, and a cyano group.

At step 56, the method 50 includes mixing at least one coupling agent with the first mixture containing the first intermediate (202) to generate a second intermediate (204) in a second mixture, as depicted in FIG. 2A. The first intermediate is functionalized/modified to cover the surface of the first intermediate with alkoxysilane molecules, resulting in generation of the second intermediate (204). In an embodiment, the surface modification is performed with aminopropyltrimethoxysilane (APTES) in the presence of one or more coupling agents. Optionally, the surface modification may be performed by isocyanatopropyltriethoxysilane (ICPTS), mercaptopropyltrimethoxysilane (MPTS), or any other salinization agents known in the art.

This reaction may be carried out in the presence of one or more coupling agents like (1-cyano-2-ethoxy-2-oxoethylidenaminooxy)dimethylamino-morpholino-carbenium hexafluorophosphate (COMU) N,N′-diisopropylcarbodiimide/hydroxybenzotriazole (DIC/HOBt), N-[(dimethylamino)-¹H-1,2,3-triazolo-[4,5-b]pyridin-1-ylmethylene]-N-methylmethanaminium hexafluorophosphate N-oxide (HATU), (benzotriazol-1-yloxy)tripyrrolidinophosphonium hexafluorophosphate (PyBOP), n-propylphosphonic anhydride (T3P®), and 1-ethyl-3-(3-dimethyl aminopropyl)carbodiimide hydrochloride (EDCI). In a preferred embodiment, the coupling agents are HOBT, and/or EDCI.

The molar ratio of HOBT to EDCI may be in a range of 1:1 to 2:1, preferably about 1.2:1. Similarly, the molar ration of EDCI to APTES is in a range of 1:2 to 2:1, preferably about 1:1. In some embodiments, the molar ratio of HOBT to APTES is in a range of 1:2 to 2:1, preferably about 1.2:1. The reaction is carried out for a period of 18-36 hours, preferably about 20-30 hours, more preferably about 24 hours, to obtain the second intermediate (204). In some embodiments, this reaction may be carried out under anhydrous conditions to prevent hydrolyzation of APTES functional groups, which could cause premature condensation. Other ranges are also possible.

In some embodiments, the second intermediate has a formula (V)

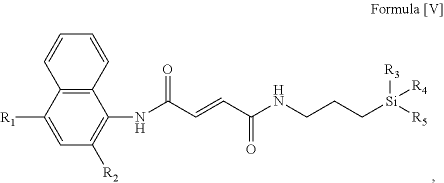

where R₁, R₂, R₃, R₄, and R₅ are each independently selected from the group consisting of hydrogen, an optionally substituted alkyl, an optionally substituted cycloalkyl, an optionally substituted alkoxy, a hydroxyl group, a halogen group, a nitro group, a sulfonic acid group, a sulfonate group, and a cyano group.

At step 58, the method 50 includes mixing a silane agent and a base with the second mixture containing the second intermediate to generate a crude product (206) in a third mixture, as depicted in FIG. 2A. Silane agents are silicon-based chemicals that contain both inorganic reactivity and organic reactivity in the same molecule. A general structure can be described as (RO)₃SiCH₂CH₂CH₂—X, where RO represents the inorganic reactivity group or a hydrolyzable group (for example, methoxy, ethoxy, acetoxy, thiol, or aldehyde) and X represents a group containing an organic reactivity group (for example, amino, methacryloxy, or epoxy) and X can also include additional carbons (—(CH₂)ₙ) and may or may not include functional groups.

Suitable examples of silane agents include include, phenyltriethoxysilane (PTES), tetraethoxysilane (TEOS), tetramethoxysilane (TEMOS), n-octyltriethoxysilane, octadecyltriethoxysilane, dimethyldimethoxysilane (DMDMOS), (3-mercaptopropyl) trimethoxysilane, (3-mercaptopropyl) triethoxysilane, (mercapto) triethoxysilane, (3-aminopropyl) triethoxysilane, 3-(2-aminoethylamino) propyltrimethoxysilane, 3-[bis (2-hydroxyethyl) amino] propyltriethoxysilane, hexadecyltrimethoxysilane, phenyltrimethoxysilane, N-[3-(trimethoxysilyl) propyl]-1,2-ethanediamine and acetoxyethyltriethoxysilane, 2-hydroxy-4-(3-triethoxysilylpropoxy) diphenyl ketone, methyltriethoxysilane, vinyltrimethoxysilane; (3-glycidoxypropyl) trimethoxysilane, (benzoyloxypropyl) trimethoxysilane, sodium 3-trihydroxysilylpropylmethylphosphonate, (3-trihydroxysilyl)-1-propanesulphonic acid, and (diethylphosphonatoethyl) triethoxysilane. In a preferred embodiment, the silane agent is TEOS.

The pH of the third mixture was adjusted with a base. The base may be an organic or an inorganic base. In an embodiment, the base is an inorganic base. Suitable examples of inorganic bases include sodium, potassium, or ammonium hydroxide. In a preferred embodiment, the base is sodium hydroxide. The reaction is carried out for a period of 5-15 hours, preferably 7-10 hours, more preferably about 8 hours, to generate the crude product in the third mixture. Other ranges are also possible.

At step 60, the method 50 includes dialyzing the third mixture (252) containing the crude product (206), evaporating, and drying to form the nanocomposite material (258), as depicted in FIGS. 2A and 2B. The third mixture is dialyzed to separate the nanocomposite from the crude material (254), as depicted in FIG. 2B. This is a purification technique where all the unreacted reagents that are soluble in water are removed from the crude product. In an embodiment, the dialyses membrane has a molecular weight of about 3.5 KDa, or more preferably about 3 kDa.

Optionally, other purification methods such as membrane filtration may be performed instead of dialyses. The dialyses process may be carried out by putting the crude material in a large amount of water. In some embodiments, the dialyses may be carried out with stirring using a stirrer, a magnetic bar, an ultrasonic bath, or a homogenizer, at a temperature of between 0 and 35° C., preferably between 10 to 30° C., more preferably at room temperature, for a period of between 12 hours to and 72 hours, preferably for about 48 hours. Other ranges are also possible. Further to dialyses, the water evaporated by drying to form the nanocomposite material. The drying may be carried out by air-drying or my oven-drying to obtain the NSPs of Formula (I).

The NSPs prepared by the method of present disclosure has a thermal stability up to a temperature of about 200° C. as determined by thermogravimetric analysis (TGA)—in other words, the nanocomposite material is thermally stable, and can withstand the conditions, without loss in chemical/physical properties.

The nanocomposite material thus prepared can be deposited at least partially on the surface of the substrate to form the sensor. The deposition of the nanocomposite material on the substrate is one of the critical factors that affect the performance of the sensor. A drop-casting technique was applied to ensure uniform deposition of the nanocomposite material on the substrate. In this method, a solution containing the nanocomposite material is cast on a substrate, followed by the evaporation of the solvent to obtain the sensor.

To elaborate, the nanocomposite material is mixed in a solvent to form a fourth mixture. Suitable examples of the solvent include, but are not limited to, hexane, chloroform, tetrahydrofuran, dichloromethane, ethanol, and mixtures thereof. The method further includes drop casting the fourth mixture onto a surface of the substrate and drying to form the sensor having a layer of the nanocomposite material at least partially covered on the surface of the transparent substrate. The solvent may be evaporated by drying/heating the substrate at a temperature range of 30-150° C., preferably 50-120° C. Other ranges are also possible. The drying may be performed in a vacuum, microwave, etc. Parameters such as concentration of the nanomaterial composite in the solution, deposition time, thickness of the nanocomposite material on the substrate, temperature, can be varied to obtain the sensor with desired properties. Such variations are obvious to a person skilled in the art. Morphological analysis reveals that the NSPs are uniformly disposed on the surface of the substrate. The NSPs are in the form of agglomerates having an average particle size of 30 to 90 nm. Other ranges are also possible.

The sensor serves as a working electrode in a potentiostat test system. During operation, when the working electrode, reference electrode, and counter electrode are immersed in the liquid to be tested (e.g., seawater), the working electrode communicates with the other electrodes, to generate a test result that is indicative of the concentration of mercury ions in the liquid.

A mercury ion detection method is described. The method includes contacting an aqueous composition containing mercury ions with the sensor to adsorb the mercury ions on the NSPs and generate a signal corresponding to a fluorescence intensity by the sensor. The sensor achieves maximum fluorescence intensity when a mole ratio of the NSPs to the mercury ions present in the aqueous composition is in a range of 1:5 to 1:1, preferably 1:4 to 1:2, or even more preferably about 1:3. Other ranges are also possible. In some embodiments, the signal would increase at least 0.001%, 0.01%, 0.1%, 1%, 10%, 20%, 50%, 70% or more, compared to the signal of a control sample (without Hg²⁺). For example, an increase in resistance indicates the presence of Hg²⁺ ions in the sample.

In some embodiments, the sensor prepared by the method of the present disclosure has a detection limit of 1 ppb by weight for mercury ions, and a linearity range of 0.1 ppb to 10 ppm by weight. In some further embodiments, the sensor has a zeta potential value of −60 to −20 mV, preferably −55 to −25 mV, preferably −50 to −30 mV, preferably −45 to −35 mV, or even more preferably about −40 mV. In some preferred embodiments, the sensor has a maximum fluorescence at the excitation wavelength of 230 to 240 nm, or preferably about 235 nm. In some more preferred embodiments, the sensor of the present disclosure has a capability to detect a ppb concentration level of mercury ions (Hg²⁺) in the presence of one or more interfering cations selected from La³⁺, Y²⁺, Mn²⁺, Sr³⁺, Ba²⁺, Ce³⁺, Mo³⁺, Pb²⁺, Ni²⁺, Co²⁺, Ag⁺, Cd²⁺, and Cr²⁺ with high selectivity.

### EXAMPLES

The following examples demonstrate the sensor for detecting mercury ions, as described herein. The examples are provided solely for illustration and are not to be construed as limitations of the present disclosure, as many variations thereof are possible without departing from the spirit and scope of the present disclosure.

### Example 1: Materials

All chemicals were purchased and used without further purification. These chemicals include 4-amino-3-hydroxy-1-naphthalene sulfonic acid (ACS reagent, ≥90%, Sigma Aldrich), sodium hydroxide (≥98%, Flukes, Hampton, USA), 3-aminopropyl) triethoxysilane (APTES, 99%, Sigma-Aldrich), tetraethyl orthosilicate (TEOS, ≥99%, Sigma-Aldrich), hydroxy benzotriazole (HOBT, ≥97%, Sigma-Aldrich), triethylamine (≥99%, Sigma-Aldrich), 1-ethyl-3-(3-dimethyl aminopropyl)carbodiimide hydrochloride (EDCI, ≥99%, Sigma-Aldrich), ethyl acetate (≥99.7%, Honeywell, USA), and 1-pyrenecarboxylic acid (97%, Sigma-Aldrich).

### Example 2: Characterization Techniques

¹H-NMR spectra were measured on a 400 MHz spectrometer (Bruker AVANCE III) using tetramethylsilane (TMS) as an internal standard and water (D₂O) as a deuterated solvent. FTIR spectra were recorded on a PerkinElmer 16F PC spectrophotometer (PerkinElmer Inc. USA) by making pellets of the samples with KBr. The phase of unmodified silica and NSPs were evaluated by an X-ray diffractometer (Rigaku MiniFlexII, Japan) with Cu Kα1 radiation (γ=0.15416 nm). The surface morphology of the samples was analysed via FESEM (Lyra-3, Tescan, Czech Republic), accelerating the voltage up to 30 kV. The samples were dispersed in de-ionized water, deployed on the stubs with double-side Cu-tap, and allowed to dry for 2 h before Au coating. The assessment of organic attachment with silica nanoparticles was also confirmed by thermogravimetric analyses (TGA) using TGA 1 STAR^{e}System (Mettler Toledo, USA) under Argon atmosphere keeping the flow rate 20 mL min⁻¹ from ambient temperature to 800° C. at a rate of 10° C. min⁻¹. Zetasizer nano (ZEN3600, Malvern, UK) was used to investigate the surface charge and zeta potential of NSPs by dispersing the sample in deionized water. The spectrofluorometer (FP-8500, JASCO) was used to record the PL spectra for developed NSPs and their samples with various mercury solutions at the excitation wavelength (235 nm) and bandwidth (5 nm).

### Example 4: Preparation of Hg²⁺ Solutions

The stock solutions of Hg²⁺ (100 ppm, 100 mL) were prepared by diluting the standard mercury solution (1000 ppm, Sigma-Aldrich). Then, various dilutions of Hg²⁺ ions (25 mL) such as (100 ppm, 80 ppm, 60 ppm, 40 ppm, 20 ppm, 10 ppm, 5 ppm, 2 ppm, 1000 ppb, 500 ppb, 200 ppb, 50 ppb, 20 ppb, 10 ppb, 5 ppb, 2 ppb, 1 ppb and 0 ppb) were prepared by applying dilution formula (C₁V₁═C₂V₂).

### Example 5: Preparation of the NSPs Dispersions

The stock dispersion of NSPs (100 ppm, 100 mL) was prepared by adding 10.0 mg of NSPs in deionized water (100 mL) and dispersed it uniformly by using a probe sonicator (UP400St). Then, the further stock dispersions of NSPs (80 ppm, 60 ppm, 40 ppm, and 20 ppm) were prepared by applying a dilution formula.

### Example 6: Mixing of the NSPs with Hg²⁺ Ions

Equal volumes of NSPs (40 ppm) and Hg²⁺ solutions (100 ppm, 80 ppm, 60 ppm, 40 ppm, 20 ppm, 10 ppm, 5 ppm, 2 ppm, 1000 ppb, 500 ppb, 200 ppb, 50 ppb, 20 ppb, 10 ppb, 5 ppb, 2 ppb, 1 ppb and 0 ppb) were mixed in the bottles. The final concentration of NSPs in each bottle was 20 ppm. At the same time, the final concentrations of Hg²⁺ ions were 50 ppm, 40 ppm, 30 ppm, 20 ppm, 10 ppm, 5 ppm, 2.5 ppm, 1 ppm, 500 ppb, 250 ppb, 100 ppb, 50 ppb, 10 ppb, 5 ppb, 1 ppb and 0 ppb in the final dispersions.

### Example 7: Mixing of NSPs with Other Metal Cations

The major cations of seawater such as La³⁺, Y2+Mn²⁺, Sr³⁺, Ba²⁺, Ce³⁺, Mo³⁺, Pb²⁺, Ni²⁺, Co²⁺, Ag⁺, Cd²⁺, Cr²⁺, Na⁺, K⁺, Ca²⁺, and Mg²⁺ ions were tested for selectivity of mercury sensing. Therefore, the stock solution of each metal cation (100 ppm, 100 mL) was prepared from its standard solution (1000 ppm, Sigma-Aldrich) or by mixing its salts. Then, 40 ppm of the diluted solution was prepared for each metal cation by applying the dilution formula. A similar protocol was adopted for mixing NSPs (40 ppm) dispersion with metal cation solution (40 ppm) to get the final dispersion of 20 ppm each.

### Example 8: Synthesis of Naphthalene-Based Silica NPs (NSPs)

FIG. 2A (200) depicts a synthetic scheme of making NSPs. In this one-pot multistep synthesis, 4-amino-3-hydroxy-1-naphthalene sulfonic acid (1.0 g, 0.00418 mmol) was taken in a clean and dried round bottom flask, followed by the addition of anhydrous dimethylformamide (DMF, 20 mL). Hünig's base (1.45 mL, 0.00836 mmol) or N,N-diisopropylethylamine was added to the reaction flask and stirred in the mixture for 15 minutes, followed by the addition of maleic anhydride (0.41 g, 0.00418 mmol) in small portions. The reaction was allowed to stir for 24 hours to get intermediate I (202). Then, the amide coupling agents hydroxybenzotriazole or HOBT (0.508 g, 0.00502 mmol) and 1-ethyl-3-(3-dimethylaminopropyl)carbodiimide or EDCI (0.535 g, 0.00460 mmol) were added along with (3-aminopropyl)triethoxysilane or APTES (0.739 mL, 0.00418 mmol) to the reaction flask and continued the stirring for another 24 hours to achieve intermediate II (204). In the end, tetraethyl orthosilicate or TEOS (0.817 mL, 0.00418 mmol) was added to the mixture with NaOH (13 mM) and adjusted the pH of the mixtures ≥9 to facilitate the hydrolysis-condensation reaction. The reaction was continued for 8 hours at room temperature to obtain a crude product of NSPs (206). The product formed possesses high dispersibility in the water phase and did not partition in any organic phase.

FIG. 2B (250) depicts a method of purifying the crude NSPs. After the hydrolysis-condensation reaction (252), the crude NSPs were purified using a dialysis membrane (3.5 kDa). This was carried out by dialyzing the crude NSPs for 48 hours and changing de-ionized water after 8 hours. As can be observed, all the unreacted materials and reagents soluble in water were removed during the dialysis, till the time an equilibrium was attained (254). The water was evaporated by air drying, to yield NSP (256). The NSPs were grounded to carry out other characteristic analyses. They can further be dispersed onto a substrate to form a sensor for detection of mercury ions (258).

FTIR (KBr): v (cm⁻¹)=3467, 2971, 2931, 2880, 1699, 1653, 1384, 1190, 1086, 1049, 767, 657, 457.

¹H-NMR (400 MHz, D₂O): 6=1.214 (t, 2H), 3.007 (m, 2H), 3.055 (t, 2H), 6.787-6.928 (2×d, 1H), 7.455-7.539 (2×d, 1H), 7.676-7.774 (2×d, 1H), 8.427-8.465 (d, 1H).

### Example 9: Photoluminescence (PL) Experiments

The spectrofluorometer was employed to record the PL spectra of NSPs at 235 nm. The developed NSPs were ultrasonicated for 60 min in DI water to get a well-dispersed suspension. All the measurements for Hg²⁺ solutions (0.5 ppb-50 ppm) and other cationic solutions (0.05 mM) were performed under ambient conditions. The sequential increment in the concentrations of Hg²⁺ ions from 0.5 ppb to 50 ppm was used to evaluate the sensing properties of NSPs (20 ppm). The selectivity of NSPs for Hg²⁺ was also assessed in the presence of pervasive cations (i.e., La³⁺, Y2+, Mn²⁺, Sr³⁺, Ba²⁺, Ce³⁺, Mo³⁺, Pb²⁺, Ni²⁺, Co²⁺, Ag⁺, Cd²⁺, Cr²⁺, Ca²⁺, Mg²⁺, K⁺, Na⁺, and seawater samples). Fluorescence spectra were taken 20 minutes after dissolving the metal cations in DI water and mixing them with the sensor. The seawater salinity was calculated and found to be about 36.03 g/L.

### Example 10: Mechanism of NSPs Formation

The synthesis of covalently attached naphthalene-based silica NPs was accomplished using the one-pot multistep synthesis approach. In this method, initially, a ring-opening reaction was carried out between maleic anhydride and 4-amino-3-hydroxy-1-naphthalene sulfonic acid in the presence of Hunig base [O. Abdulaziz Alghamdi, M. Mansha, A. N. Kalanthoden, M. S. Kamal, M. Khan, Fracturing fluid applications of carboxylate-terminated low molecular weight PEI and CTAB formulations, Colloid Interface Sci. Commun. 49 (2022) 100643; and M. Mansha, A. Madhan Kumar, A. Y. Adesina, I. B. Obot, M. Khan, A novel trans-esterified water soluble hyperbranched polymer for surface protection of X60 steel: Experimental and theoretical approach, J. Mol. Liq. 349 (2022) 118091, each incorporated herein by reference in their entirety]. The formed intermediate I was allowed to undergo an amide coupling reaction with APTES in the presence of EDCI and HOBt coupling agents [M. Mansha, U. U. Kumari, Z. Cournia, N. Ullah, Pyrazole-based potent inhibitors of GGT1: Synthesis, biological evaluation, and molecular docking studies, Eur. J. Med. Chem. 124 (2016) 666-676; and M. Mansha, N. Ullah, K. Alhooshani, Synthesis of structural analogues of GGT1-DU40, a potent GGTase-1 inhibitor, Zeitschrift Für Naturforsch. B. 71 (2016) 333-344, each incorporated herein by reference in their entirety] to make intermediate II. The hydrolysis reaction followed by condensation was carried out by adding TEOS under basic conditions maintaining pH ≥9 (Stobers synthesis program) [S. A. Khan, M. H. Al-Jabari, M. Mansha, S. Ali, Z. H. Yamani, Hydrophobic, partially hydrophobic, and hydrophilic ZnO@SiO₂ nanoparticles as fluorescent partitioning tracers for oil sensing applications, J. Mol. Liq. 360 (2022) 119505, incorporated herein by reference in its entirety]. The obtained product has high dispersibility or affinity in the water phase and shows no significant partitioning behavior in any organic solvent. The remaining product in the water phase was purified using a dialysis membrane. All the unreacted materials and reagents soluble in water were removed during the dialysis.

### Example 11: Characterization of NSPs

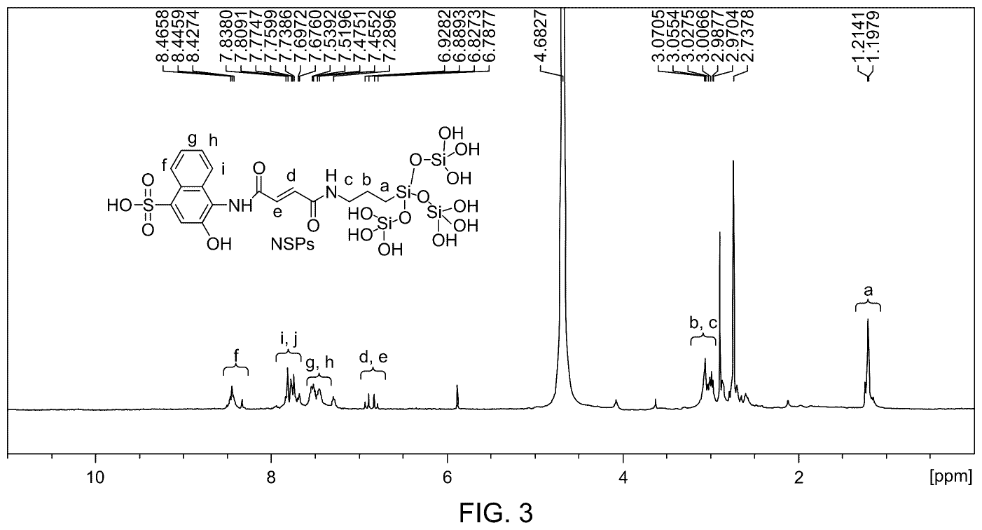

The chemical structure of NSPs was investigated by ¹H-NMR and FTIR spectroscopy. The ¹H-NMR spectrum of NSPs showed that methylene protons of (—NH—CH₂—CH₂—CH₂—Si(O₃)—), (—NH—CH₂—CH₂—CH₂—Si(O₃)—) and (—NH—CH₂—CH₂—CH₂—Si(O₃)—) detected at 1.197 ppm, 2.980 ppm, and 3.006 ppm, respectively, in deuterated water solvent [F. Kunc, V. Balhara, A. Brinkmann, Y. Sun, D. M. Leek, L. J. Johnston, Quantification and Stability Determination of Surface Amine Groups on Silica Nanoparticles Using Solution NMR, Anal. Chem. 90 (2018) 13322-133309, incorporated herein by reference in its entirety]. The alkene component (—HC═CH—) of the molecule appeared between 6.787-6.928 ppm as two doublets. The aromatic protons of naphthalene appeared between 7.455-8.465 ppm, where the proton attached to 2C adjacent to hydroxyl and sulfonic acid functional groups, and the proton as a substituent at 6C appeared in the region of 7.455-7.539 ppm, while the protons substituents at 7C and 8C showed between 7.676-7.774 ppm. The proton of the 9C position appeared between 8.427-8.465 ppm (FIG. 3).

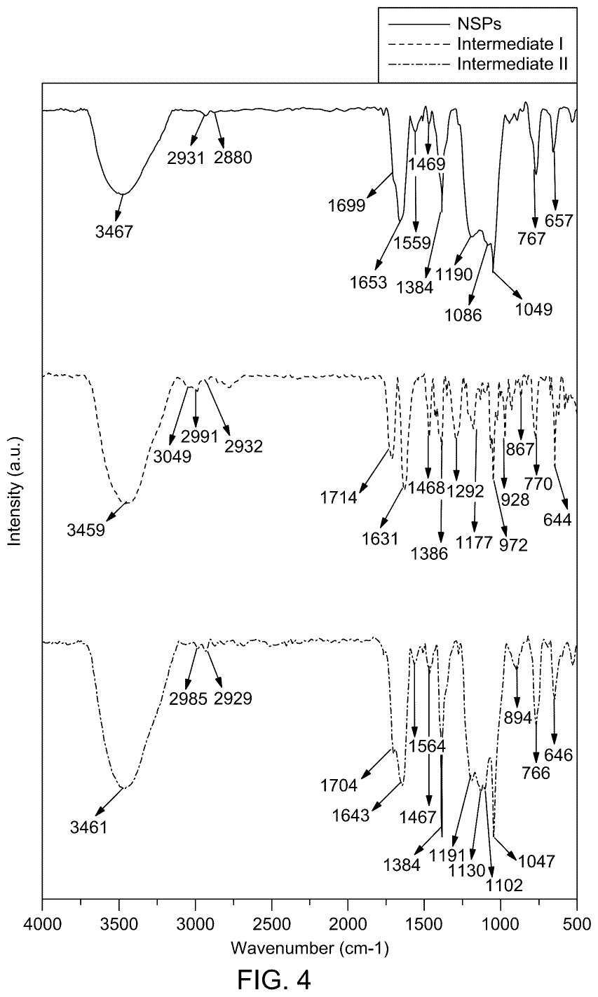

The nature of functional groups for intermediate I, II, and NSPs was ascertained by FTIR spectroscopy (FIG. 4). FTIR spectrum of intermediate I showed a broad band at 3459 cm⁻¹ (starting and terminating at 3750 and 3150 cm⁻¹) representing the carboxylic —OH group with overlapping of amide (—NH) group. However, the bending vibration of N—H could be detected at 1640 cm⁻¹, which is found to overlap with amide carbonyl in the same region. The aromatic stretching of —CH also appeared at 3049 cm⁻¹, and the carboxylic carbonyl (—COOH) was detected at 1714 cm⁻¹. The FTIR of intermediate II and NSPs showed resemblances as both shared the same functionalities. FTIR spectrum of NSPs exhibited characteristic vibrations bands of the —OH group, while the amide carbonyl (—CONH—) group created from the coupling reaction of amine and the carboxylic group showed a downward shift from 1714 cm⁻¹ to 1699 cm⁻¹ and two different peaks appeared as one vibration band. Furthermore, the aliphatic nature of the final product for an aminopropyl component is supported by the stretching bands at 2931 cm⁻¹ and 2880 cm⁻¹, along with bending vibrations at 1559 cm⁻¹ and 1469 cm⁻¹. The presence of silica nanoparticles is confirmed by symmetric and antisymmetric vibration modes of Si—O—Si at 767 cm⁻¹ and 1190 cm¹, respectively. The C—N stretching band was also observed at 1049 cm⁻¹ and found intensively overlapped with silanol groups [M. Ghanimati, M. Jabbari, A. Farajtabar, S. A. Nabavi-Amri, Adsorption kinetics and isotherms of bioactive antioxidant quercetin onto amino-functionalized silica nanoparticles in aqueous ethanol solutions, New J. Chem. 41 (2017) 8451-8458, incorporated herein by reference in its entirety].

The thermal stability of naphthalene-based (organic moiety) NSPs was investigated by heating the material from room temperature to 800° C. (FIG. 5). The first weight loss (10.50 wt. %) was observed up to 125° C. due to the physically adsorbed water molecules on the surface of NSPs. The second weight loss of 29.01 wt. % between 125-400° C. is attributed to the elimination of naphthalene-based organic moiety showing the degradation temperature (T_{d}) at 280° C. [Y. Do Kim, J. H. Cho, C. R. Park, J.-H. Choi, C. Yoon, J. P. Kim, Synthesis, application and investigation of structure-thermal stability relationships of thermally stable water-soluble azo naphthalene dyes for LCD red color filters, Dye. Pigment. 89 (2011) 1-8, incorporated herein by reference in its entirety]. The final weight loss (29.20 wt. %) corresponded to the decomposition of organosilicate frameworks (maleic and silanol components) [J. Lee, J.-H. Kim, K. Choi, H.-G. Kim, J.-A. Park, S.-H. Cho, S. W. Hong, J.-H. Lee, J. H. Lee, S. Lee, S. Y. Lee, J.-W. Choi, Investigation of the mechanism of chromium removal in (3-aminopropyl)trimethoxysilane functionalized mesoporous silica, Sci. Rep. 8 (2018) 12078, incorporated herein by reference in its entirety]. The observed weight loss confirms the covalently attached organic species with silica nanoparticles. These results showed that the NSPs-based chemosensor is thermally stable up to about 200° C. and can be applied for large scale applications.

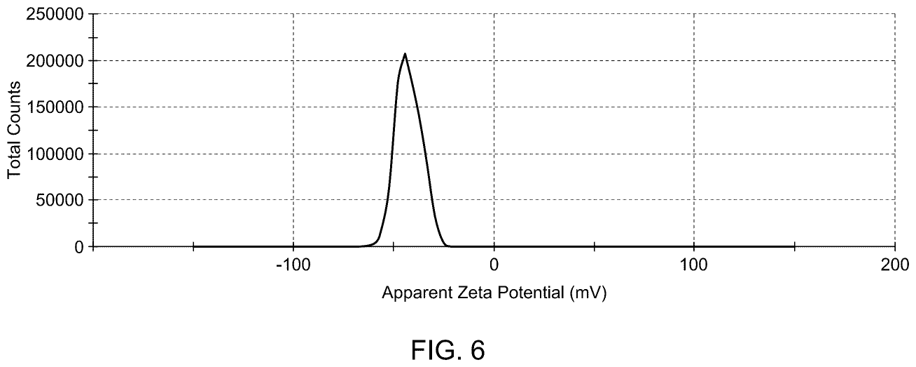

The approximate surface charge and zeta potential value of the synthesized NSPs were determined in deionized water by the dynamic light scattering (DLS) technique. The zeta potential value of NSPs predicts them as negatively charged species having a value of −42 mV (FIG. 6). The results indicate that NSPs are highly stable in the aqueous phase. It is assumed that these particles have built strong hydrogen bonding with water molecules in the presence of sulfonate (—SO₃H), hydroxyl (—OH), and amide (—NHCO—) functionalities. The higher zeta potential value indicated that NSPs can be successfully employed as a chemosensor in aqueous environments [Wang, B. Li, L. Zhang, L. Liu, Q. Zuo, P. Li, A highly selective regenerable optical sensor for detection of mercury(ii) ion in water using organic-inorganic hybrid nanomaterials containing pyrene, New J. Chem. 34 (2010) 1946, incorporated herein by reference in its entirety].

### Example 12: Structural and Morphological Analysis

The crystal structure and purity of unmodified silica nanoparticles and the NSPs were investigated by X-ray diffraction (XRD) analysis. The amorphous nature of silica NPs was confirmed by observing a broad diffraction peak in the XRD pattern that appeared at 20 position of 23°, as illustrated in FIG. 7 (JCPDS No. 00-001-0649) [A. M. Khan, F. Shafiq, S. A. Khan, S. Ali, B. Ismail, A. S. Hakeem, A. Rahdar, M. F. Nazar, M. Sayed, A. R. Khan, Surface modification of colloidal silica particles using cationic surfactant and the resulting adsorption of dyes, J. Mol. Liq. 274 (2019) 673-680; and A. U. Rehman, S. A. Khan, S. Ali, M. F. Nazar, A. Shah, A. Rahman Khan, A. M. Khan, Counterion engineered surfactants for the novel synthesis of colloidal metal and bimetal oxide/SiO₂ materials with catalytic applications, Colloids Surfaces A Physicochem. Eng. Asp. 571 (2019) 80-85, each incorporated herein by reference in their entirety]. Though no extra peaks were observed for unwanted reagents in the entire XRD spectra, which confirmed the formation of high-purity silica NPs. A similar pattern was observed for NSPs that also confirm the existence of silica nanoparticles in the sample after modification with naphthalene-based (organic moiety).

The surface morphology and particle size of as-synthesized particles were observed via field emission scanning electron microscopy (FESEM). FIGS. 8A and 8B represent high-resolution FESEM images of unmodified silica and naphthalene-based silica particles (NSPs). The well-dispersed spherical-shaped silica particles are formed having an average diameter of about 40 nm (FIG. 8A). However, the average particle size of NSPs increased to about 60 nm during the hydrolysis-condensation reaction due to the addition of TEOS silica precursor (FIG. 8B). Moreover, the covalently attached naphthalene increased the agglomeration and diffusion of silica particles may be due to the 7E-7E interactions between the organic moieties, which further confirms the naphthalene attachment with silica particles.

### Example 13: UV-Visible Absorption and Photoluminescence Studies

The measurement of the UV-Vis spectrum of NSPs showed three different absorption peaks appearing at 235 nm, 290 nm, and 336 nm, respectively (FIG. 9). The absorption wavelength at 336 nm corresponds to the one-electron excitation from HOMO-1→LUMO (n→π*) that is found near the experimental values of UV-Vis spectrum of 4-amino-3-hydroxy-1-naphthalene sulfonic acid measured in ethanol solvent. The shortchange in wavelength is observed because of extended conjugation due to maleic acid attachment with the main molecule. The absorption band was detected at 290 nm due to the electronic transition of HOMO-1→LUMO (n→π*) [S. Sebastian, S. Sylvestre, N. Sundaraganesan, M. Amalanathan, S. Ayyapan, K. Oudayakumar, B. Karthikeyan, Vibrational spectra, molecular structure, natural bond orbital, first order hyperpolarizability, TD-DFT and thermodynamic analysis of 4-amino-3-hydroxy-1-naphthalenesulfonic acid by DFT approach, Spectrochim. Acta Part A Mol. Biomol. Spectrosc. 107 (2013) 167-178, incorporated herein by reference in its entirety]. The absorption band observed at 235 nm might be because of naphthalene ring π→π* electronic transitions.

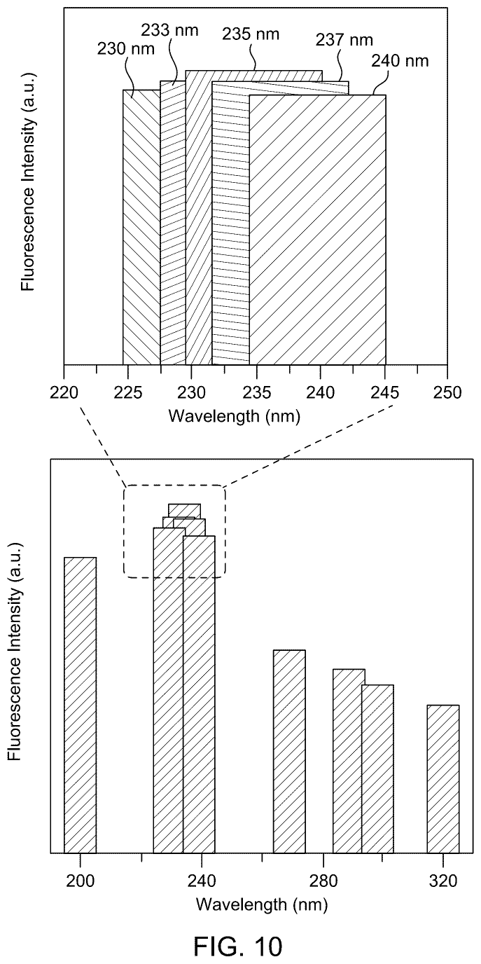

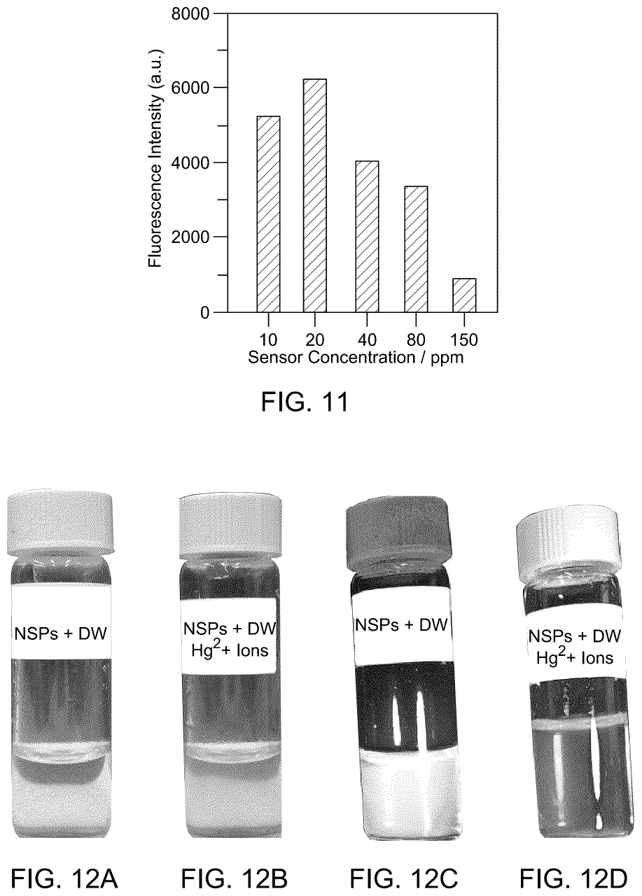

After the UV-visible spectrum analysis, the maximum intensity of fluorescence emission was measured via photoluminescence studies by exciting the molecule at different wavelengths, such as 200 nm, 240 nm, 280 nm, and 320 nm. The results showed that the excitation wavelength of 240 nm exhibited maximum fluorescence intensity (about 6200 a.u.) as compared to other low-energy wavelengths (FIG. 10). Further narrowing down the excitation wavelength range, the NSPs were excited at 230 nm, 233 nm, 235 nm, 237 nm, and 240 nm. It was observed that the excitation at 235 nm showed maximum fluorescence intensity, as demonstrated in the inset of FIG. 10. Likewise, the fluorescence intensity of NSPs was also assessed at various concentrations such as 10, 20, 40, 80, and 150 ppm solutions by exciting the molecule at 235 nm and found the emission maxima at 20 ppm, as shown in FIG. 11. Therefore, the concentration (20 ppm) and excitation wavelength (235 nm) were used for fluorescence measurements to determine the turn-on/off response in the presence of Hg²⁺ ions (0.5 ppb to 50 ppm).

The luminescent characteristics of NSPs solution in de-ionized water with and without mercury ions were also examined under normal light and UV-light illumination (FIG. 12). The pictograms show that under normal light, NSPs without mercury and with mercury showed no luminescence (FIGS. 12A and 12B). The solution of NSPs in the absence of mercury showed dark blue under UV light illumination, while its color disappeared upon adding mercury solution (FIGS. 12C and 12D). This indicates that NSPs behave as turn-off sensing probes for mercury ions detection.

The photoluminescence (PL) spectra of NSPs were recorded by measuring the fluorescence emission intensity versus wavelength in the range of 320-650 nm. By considering the UV-Vis (FIG. 9) and PL spectra (FIG. 11) of NSPs, the fluorescence intensity was attained by employing an concentration of sensor (20 ppm) and excitation wavelength (235 nm). After the addition of a known concentration of Hg²⁺ ions (i.e., 0-50 ppm), the PL spectral intensity of NPs was suppressed linearly by the successive addition of Hg²⁺ ions and became constant at 40 ppm (FIG. 13). This can be attributed to the formation of a stable Hg-based complex with NSPs which exhibits the turn-off quenching mechanism. Static and dynamic quenching are two types of quenching, where formal and lateral quenching occurs due to the formation of complex and random collisions between the quencher and emitter, respectively. The electron is transferred from the emitter to the quencher in both cases. This electron transfer rate can be evaluated by the equation 1 [J. R. Lakowicz, Principles of Fluorescence Spectroscopy, Springer US, Boston, M A, 1999; and K. P. L. Kuijpers, C. Bottecchia, D. Cambid, K. Drummen, N.J. König, T. Noel, A Fully Automated Continuous-Flow Platform for Fluorescence Quenching Studies and Stern-Volmer Analysis, Angew. Chemie. 130 (2018) 11448-11452, each incorporated herein by reference in their entirety].

$$\frac{{F}^{0}}{F} = 1 + {K}_{SV} [ Q ] \qquad ( 1 )$$

Where K_{SV}, Q, F, and F° are Stern-Volmer constant, quencher concentration, and fluorescence intensity of the chemosensor with and without Hg²⁺ ions, respectively [J. Keizer, Nonlinear fluorescence quenching and the origin of positive curvature in Stern-Volmer plots, J. Am. Chem. Soc. 105 (1983) 1494-1498, incorporated herein by reference in its entirety]. The static quenching was again confirmed from the straight line observed in the Stern-Volmer plot between F°/F and [Q], as demonstrated in FIG. 14. The slope of the Stern-Volmer plot gives Kₛᵥ, which explains the quantitative measurement for the quenching phenomenon [A. A. Boali, M. Mansha, A. Waheed, N. Ullah, Synthesis and selective colorimetric detection of iodide ion by novel 1,5-naphthyridine-based conjugated polymers, J. Taiwan Inst. Chem. Eng. 91 (2018) 420-426; and M. Mansha, M. Sohail, N. Ullah, Synthesis, characterization, and properties of new 3-hexyl-2,5-diphenylthiophene: Phenylene vinylenes copolymers as colorimetric sensor for iodide anion, J. Appl. Polym. Sci. 134 (2017) 44948; each incorporated herein by reference in their entirety]. The Kₛᵥ value of NSPs in the presence of Hg²⁺ ions give 0.409×10⁶ M⁻¹ (FIG. 14). The calculated results are consistent with the literature for complex formation between sensor and quencher [S. Ali, M. Mansha, N. Baig, S. A. Khan, Cost-Effective and Selective Fluorescent Chemosensor (Pyr-NH@SiO₂ NPs) for Mercury Detection in Seawater, Nanomaterials; and Z. M. Sahin, D. Alimli, M. M. Tonta, M. E. Kose, F. Yilmaz, Highly sensitive and reusable mercury (II) sensor based on fluorescence quenching of pyrene moiety in polyacrylamide-based cryogel, Sensors Actuators B Chem. 242 (2017) 362-368, each incorporated herein by reference in their entirety]. The chemical structure and results indicate that NSPs behave as an internal charge transfer (ICT) chemosensor because it is composed of electron donating and electron accepting groups within conjugated 71 systems without the presence of a spacer. The excitation of electrons causes the redistribution of electrons that create a dipole moment. When an analyte is attached to an ICT chemosensor, the enhancement or reduction in dipole moment can be felt by a significant shift in the absorption or emission bands [M. Mansha, S. Akram Khan, M. A. Aziz, A. Zeeshan Khan, S. Ali, M. Khan, Optical Chemical Sensing of Iodide Ions: A Comprehensive Review for the Synthetic Strategies of Iodide Sensing Probes, Challenges, and Future Aspects, Chem. Rec. 22 (2022), incorporated herein by reference in its entirety]. FIG. 13 showed that adding Hg²⁺ ions to NSPs solution resulted in a blue shift of λₘₐₓ from 430 nm to 425 nm, as the concentration increased from 0.5 ppb to 40 ppm.

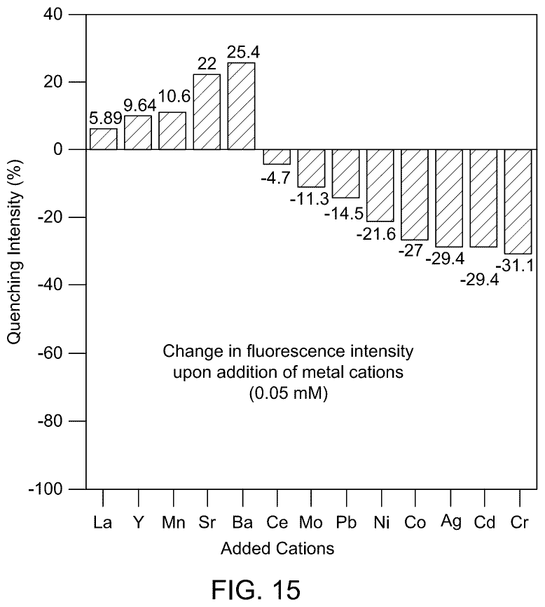

The assessment for the selectivity of NSPs for Hg²⁺ ions (10 ppm, 0.05 mM) in the presence of various cations such as La³⁺, Y2+Mn²⁺, Sr³⁺, Ba²⁺, Ce³⁺, Mo³⁺, Pb²⁺, Ni²⁺, Co²⁺, Ag⁺, Cd²⁺, and Cr²⁺ was determined (FIG. 15). For these experiments, NSPs with 20 ppm concentration were used against 0.05 mM of each metal ion to measure the quenching efficiency. The results indicate that metal ions (La³⁺, Y2+Mn²⁺, Sr³⁺, and Ba²⁺) showed a turn-on response with a slight enhancement in the fluorescence intensity, where the maximum fluorescence was enhanced by Ba²⁺ ions. Metal ions such as Ce³⁺, Mo³⁺, Pb²⁺, Ni²⁺, Co²⁺, Ag⁺, Cd²⁺, and Cr²⁺ showed a turn-off response with a decline in fluorescence intensity, which is much less than compared to Hg²⁺ ions.

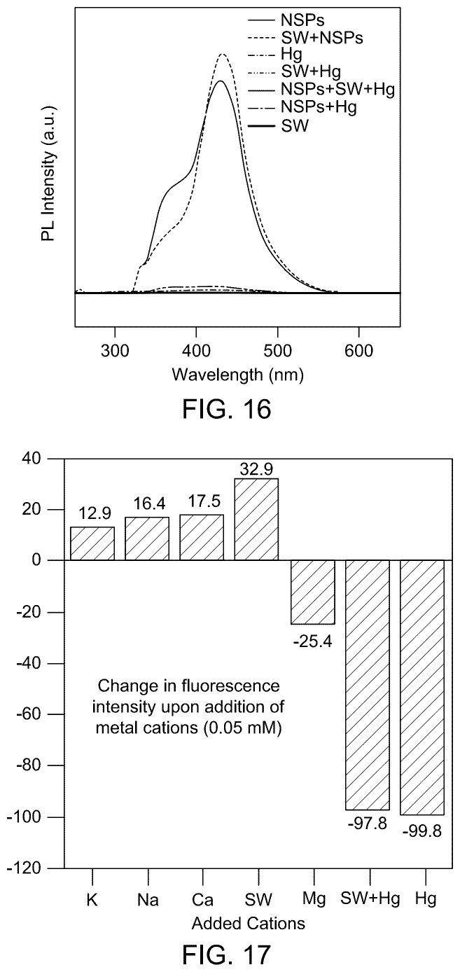

The NSPs chemosensor was also used to test the real seawater sample in the presence of Hg²⁺ ions (10 ppm, 0.05 mM), as shown in (FIG. 16). The fluorescence intensity was quenched to 97.8% after spiking the 10 ppm (0.05 mM) of Hg²⁺ ions concentration. This indicates that developed NSPs effectively recognize the Hg²⁺ ions in the seawater even with the competent metal cations present in the seawater sample. Moreover, to confirm this assumption, various metal cations (i.e., K⁺, Mg²⁺, Ca²⁺, Na⁺) were used to analyze the selectivity of NSPs chemosensor (0.05 mM), as represented in FIG. 17.

The results exhibited that the developed NSPs chemosensor has comparable detection capabilities and, in some cases, even better than reported techniques for the Hg²⁺ ions sensing in the aquatic environment, as shown in Table 1. Generally, colorimetric chemosensors are considered less sensitive than electrochemical and SERS-based sensors. However, a minute change in the sensing environment may cause a dramatic change in the selectivity of an electrochemical sensor. Likewise, Hg²⁺ ions can be detected with five ppb LOD by using a SERS-based probe [T. Senapati, D. Senapati, A. K. Singh, Z. Fan, R. Kanchanapally, P. C. Ray, Highly selective SERS probe for Hg(ii) detection using tryptophan-protected popcorn shaped gold nanoparticles, Chem. Commun. 47 (2011) 10326, incorporated herein by reference in its entirety]. Moreover, a dithizone-based sensor can detect 10 ppb by colorimetric technique [R. Sedghi, B. Heidari, H. Javadi, N. Sayyari, Design and synthesis of colorimetric sensor based on dithizone@TiO₂/poly (tert-butyl acrylate-acrylic acid) nanocomposite for fast visual detection of mercury, lead and cadmium ions in aqueous media, Environ. Nanotechnology, Monit. Manag. 18 (2022) 100670, incorporated herein by reference in its entirety]. The comparison indicates that the designed NSPs exhibit exceptional chemosensors for Hg²⁺ ions detection at a very low level (LOD: 1 ppb) in real seawater. Furthermore, the one-step synthesis and trace-level detection of Hg²⁺ ions give advantages to other sensors reported in the literature (Table 1).

TABLE 1
Various fluorescence sensors for determination of Hg²⁺ species in aqueous environments

| | | Detection | | Dynamic | | |
|---|---|---|---|---|---|---|
| Materials | Sample | limit | | range | | Ref. |
| Combination of | Environmental | 0.02 | μM | 2.5-60 | μM | M. L. Desai et al., |
| La³⁺ ion and bovine | water | | | | | Fluorescence |
| serum albumin gold | | | | | | enhancement of bovine |
| nanoclusters (La³⁺ ion- | | | | | | serum albumin gold |
| BSA-Au NCs) | | | | | | nanoclusters from La³⁺ |
| | | | | | | ion: Detection of four |
| | | | | | | divalent metal ions |
| | | | | | | (Hg²⁺, Cu²⁺, Pb²⁺, and |
| | | | | | | Cd²⁺), J. Mol. Liq. 336 |
| | | | | | | (2021) 116239. |
| Novel Rhodamine 6G- | Water sample | 30.37 | nM | 0-10 | μM | B. D. Vanjare et al., |
| based chemosensors | | | | | | Novel rhodamine based |
| PS | | | | | | chemosensor for |
| | | | | | | detection of Hg²⁺: |
| | | | | | | Nanomolar detection, |
| | | | | | | real water sample |
| | | | | | | analysis, and |
| | | | | | | intracellular cell |
| | | | | | | imaging, Sensors |
| | | | | | | Actuators B Chem. 330 |
| | | | | | | (2021) 129308. |
| Julolidine and | Drinking | 3.82 | pM | 0-5 | μM | P. Yuvaraj et al., |
| barbituric acid Jul- | water | | | | | Hydrogen Bond- |
| BA and Jul-TBA | | | | | | Assisted Colorimetric |
| | | | | | | Picomolar Level |
| | | | | | | Detection of Hg²⁺ Ions |
| | | | | | | in 100% Aqueous |
| | | | | | | Solution, ACS Sustain. |
| | | | | | | Chem. Eng. 9 (2021) |
| | | | | | | 10309-10317. |
| Xanthene- | Food samples | 41.9 | nM | 0-100 | μM | S. Erdemir et al., A |
| triphenylamine (TXS) | & living cells | | | | | switch-on xanthene- |
| | | | | | | triphenylamine based |
| | | | | | | fluorescent and |
| | | | | | | colorimetric sensor for |
| | | | | | | the detection of ultra- |
| | | | | | | trace Hg²⁺ in food |
| | | | | | | samples and living |
| | | | | | | cells, Food Chem. 376 |
| | | | | | | (2022) 131951. |
| Phenylboronic acid | Water | 15.2 | nM | — | | S. Subedi at al., A new |
| | | | | | | ratiometric fluorescent |
| | | | | | | chemodosimeter for |
| | | | | | | sensing of Hg²⁺ in |
| | | | | | | water using the |
| | | | | | | irreversible reaction of |
| | | | | | | arylboronic acid with |
| | | | | | | Hg²⁺, Sensors |
| | | | | | | Actuators B Chem. 338 |
| | | | | | | (2021) 129814. |
| Fluorescein/Thiourea | Water | 0.24 | nM | 1.0-100 | nM | E. M. Bakir at al., |
| (FLTU) | | | | | | Colorimetric detection |
| | | | | | | of Hg²⁺ ion using |
| | | | | | | fluorescein/thiourea |
| | | | | | | sensor as a receptor in |
| | | | | | | an aqueous medium, J. |
| | | | | | | Photochem. Photobiol. |
| | | | | | | A Chem. 422 (2022) |
| | | | | | | 113569. |
| Six probes (1-6) using | Water | 0.047 | pM | 0-1.1 | μM | A. Kumar et al., |
| a naphthoquinolinedione | | | | | | Chromofluorogenic |
| ring | | | | | | naphthoquinolinedione- |
| | | | | | | based probes for |
| | | | | | | sensitive detection and |
| | | | | | | removal of Hg²⁺ in |
| | | | | | | aqueous solutions, Dye. |
| | | | | | | Pigment. 198 (2022) |
| | | | | | | 110025. |
| Novel dual-emission | Water | 0.12 | nM | 0-300 | μM | H. Guo et al., In-situ |
| ratiometric fluorescent | | | | | | synthesis of carbon |
| sensor (CDs@Eu-MOFs) | | | | | | dots-embedded |
| | | | | | | europium metal- |
| | | | | | | organic frameworks for |
| | | | | | | ratiometric |
| | | | | | | fluorescence detection |
| | | | | | | of Hg²⁺ in an aqueous |
| | | | | | | environment, Anal. |
| | | | | | | Chim. Acta. 1141 |
| | | | | | | (2021) 13-20. |
| Gold nanoparticles- | Water | 4.3 | nM | 5-1000 | nM | H. Khani et al., A |
| catalyzed clock | | | | | | naked-eye colorimetric |
| reaction | | | | | | assay for detection of |
| | | | | | | Hg²⁺ ions in real water |
| | | | | | | samples based on gold |
| | | | | | | nanoparticles-catalyzed |
| | | | | | | clock reaction, J. Mol. |
| | | | | | | Liq. 345 (2022) 118243. |

| | | | | | |
|---|---|---|---|---|---|
| A novel dual-channel | Wastewater | 1.13 | μM | — | S. Erdemir, S. |

| | | | | |
|---|---|---|---|---|
| responsive fluorescent | | | | Malkondu, Dual- |
| probe RHI | | | | channel responsive |
| | | | | fluorescent sensor for |
| | | | | the logic-controlled |
| | | | | detection and |
| | | | | bioimaging of Zn²⁺ and |
| | | | | Hg²⁺, J. Mol. Liq. 326 |
| | | | | (2021) 115279. |
| Naphthalene-based | Seawater | 5 nM | 2.5 nM- | The sensor of the |
| silica nanoparticles | | (1 ppb) | 25.0 μM | present disclosure |
| (NSPs) | | | (0.5 ppb- | |
| | | | 5.0 ppm) | |

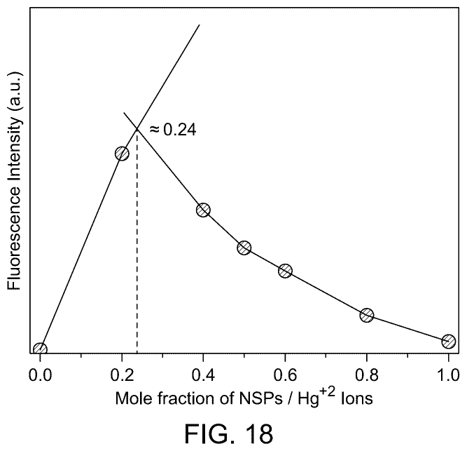

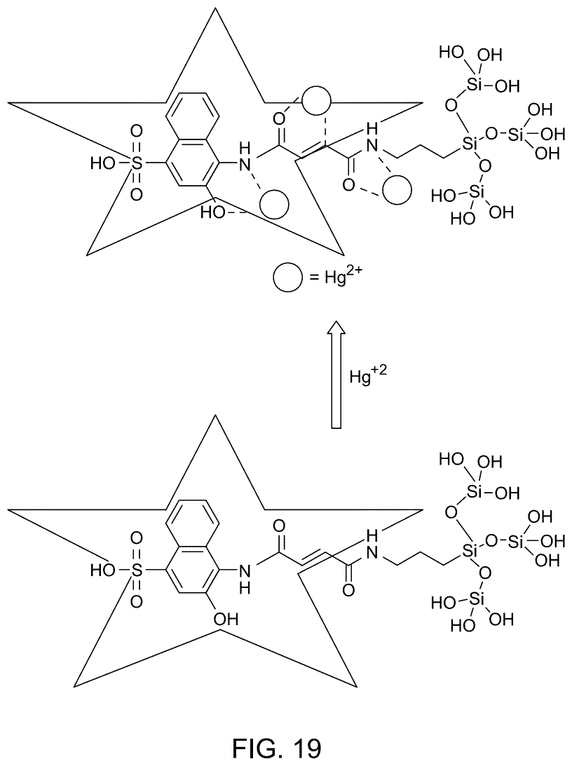

The mechanism for Hg²⁺ ions quenching by NSPs chemosensor can be explained based on complex formation of Hg with chemosensor at N and O active sites in the structure by making a stable Penta-ring. Furthermore, the estimation of binding stoichiometry between NSPs and Hg²⁺ ions was conducted by Job's plot analysis (FIG. 18). In these experiments, the total concentration of NSPs and Hg²⁺ ions were retained at 5.0 uM, and their mole ratios varied from 0 to 1. The Job's plot between the mole fractions and fluorescence intensity indicates that the fluorescence intensity attains maximum value at a mole fraction of about 0.24. These results predict that NSPs and Hg²⁺ ions share the stochiometric binding ratio of 1:3. The most suitable binding modes between them are demonstrated in a plausible attachment mechanism, as shown in FIG. 19.

Naphthalene-based silica nanoparticles were synthesized using a one-pot multiple steps synthesis approach. The chemical structure of NSPs was confirmed by ¹H-NMR and FTIR spectroscopy. The covalent attachment of naphthalene-based organic species with silica nanoparticles was verified by thermal gravimetric analysis by observing the weight loss between 125-400° C. A broad diffraction peak appeared at 20 position (about 23°), confirming the formation of amorphous silica NPs. FESEM images showed the average particle size of unmodified silica and NSPs around 40 and 60 nm, respectively. At the same time, the zeta potential value of NSPs (−42 mV) predicts that the NSPs are highly stable in the aqueous phase due to the presence of sulfonate (—SO₃H), hydroxyl (—OH), and amide (—NHCO—) functionalities at the surface of silica particles. The UV-Vis absorption band was observed at 235 nm due to π→π* electronic transitions of the naphthalene ring and showed dark blue color under UV-light illumination. The PL spectral intensity of NSPs was suppressed upon Hg²⁺ addition, attributed to the formation of a stable Hg-based complex with NSPs. The static quenching phenomenon was confirmed from the Stern-Volmer plot, and the Kₛᵥ value of NSPs in the presence of Hg²⁺ ions was 0.409×10⁶ M⁻¹. The chemical structure and PL results indicate that NSPs behave as an internal charge transfer (ICT) chemosensor due to electron-donating and accepting groups within conjugated π systems without a spacer. The developed NSPs chemosensor can reliably recognize Hg²⁺ ions (LOD: 1 ppb) with a linearity range (0.5 ppb-5.0 ppm) in a real seawater sample. The developed fluorescent chemosensor (NSPs) have great potential as highly sensitive, selective, and portable opto-chemical mercury sensors for seawater applications.

Numerous modifications and variations of the present disclosure are possible in light of the above teachings. It is therefore to be understood that within the scope of the appended claims, the invention may be practiced otherwise than as specifically described herein.

1: A sensor for the detection of mercury ion, comprising
a substrate;
a nanocomposite material at least partially covering a surface of the substrate;
wherein the nanocomposite material comprises naphthalene modified silica nanoparticles (NSPs) of formula (I) 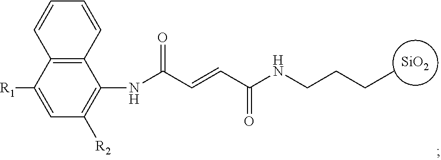
wherein the NSPs comprises a naphthalene moiety, a maleic moiety, and an alkylamine functionalized silica nanoparticle;
wherein the naphthalene moiety is covalently linked to the alkylamine functionalized silica nanoparticle via the maleic moiety; and
wherein the nanocomposite material has a thermal stability up to a temperature of about 200° C. as determined by thermogravimetric analysis (TGA).

2: The sensor of claim 1, wherein the substrate comprises a silicon portion, and a glass portion.

3: The sensor of claim 1, wherein the substrate is glass, and wherein the glass is at least one selected from the group consisting of a fluorine-doped tin oxide (FTO) glass, a tin-doped indium oxide (ITO) glass, an aluminum doped zinc oxide (AZO) glass, a niobium doped titanium dioxide (NTO) glass, an indium doped cadmium oxide (ICO) glass, an indium doped zinc oxide (IZO) glass, a fluorine doped zinc oxide (FZO) glass, a gallium doped zinc oxide (GZO) glass, an antimony doped tin oxide (ATO) glass, a phosphorus-doped tin oxide (PTO) glass, a zinc antimonate glass, a zinc oxide glass, a ruthenium oxide glass, a rhenium oxide glass, a silver oxide glass, and a nickel oxide glass.

4: The sensor of claim 1, wherein R₁, and R₂ are each independently selected from the group consisting of hydrogen, an optionally substituted alkyl, an optionally substituted cycloalkyl, an optionally substituted alkoxy, a hydroxyl group, a halogen group, a nitro group, a sulfonic acid group, a sulfonate group, and a cyano group.

5: The sensor of claim 1, wherein the naphthalene modified silica nanoparticles have a formula (II)

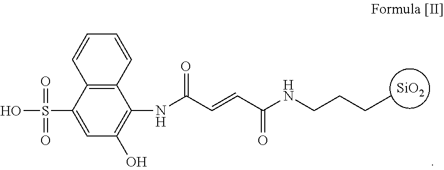

6: The sensor of claim 1, wherein the naphthalene modified silica nanoparticles are uniformly disposed on the surface of the substrate.

7: The sensor of claim 1, wherein the naphthalene modified silica nanoparticles are in the form of agglomerates having an average particle size of 30 to 90 nm.

8: The sensor of claim 1, having a zeta potential value of −60 to −20 mV.

9: The sensor of claim 1, having a maximum fluorescence at the excitation wavelength of 230 to 240 nm.

10: The sensor of claim 1, having a capability to detect a ppb concentration level of mercury ions (Hg²⁺) in the presence of one or more interfering cations selected from the group consisting of La³⁺, Y²⁺, Mn²⁺, Sr³⁺, Ba²⁺, Ce³⁺, Mo³⁺, Pb²⁺, Ni²⁺, Co²⁺, Ag⁺, Cd²⁺, and Cr²⁺.

11: A method of making the sensor of claim 1, comprising:
preparing the nanocomposite material by:
mixing a naphthalene compound, an alkyl amine, and a solvent to form a reaction mixture;
portion-wise adding maleic anhydride into the reaction mixture and mixing to form a first intermediate in a first mixture;
mixing at least one coupling agent with the first mixture containing the first intermediate to generate a second intermediate in a second mixture;
mixing a silane agent and a base with the second mixture containing the second intermediate to generate a crude product in a third mixture;
dialyzing the third mixture containing the crude product, evaporating, and drying to form the nanocomposite material.

12: The method of claim 11, wherein the naphthalene compound has a formula (III) 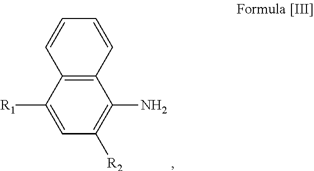
wherein R₁, and R₂ are each independently selected from the group consisting of hydrogen, an optionally substituted alkyl, an optionally substituted cycloalkyl, an optionally substituted alkoxy, a hydroxyl group, a halogen group, a nitro group, a sulfonic acid group, a sulfonate group, and a cyano group.

13: The method of claim 11, wherein the naphthalene compound is 4-amino-3-hydroxy-1-naphthalene sulfonic acid.

14: The method of claim 11, wherein the alkyl amine comprises alkyl groups having 3 to 10 carbon atoms.

15: The method of claim 11, wherein the first intermediate has a formula (IV) 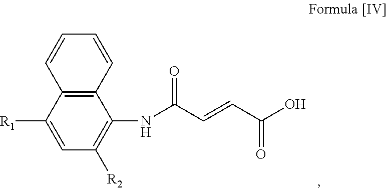
wherein R₁, and R₂ are each independently selected from the group consisting of hydrogen, an optionally substituted alkyl, an optionally substituted cycloalkyl, an optionally substituted alkoxy, a hydroxyl group, a halogen group, a nitro group, a sulfonic acid group, a sulfonate group, and a cyano group.

16: The method of claim 11, wherein the second intermediate has a formula (V) 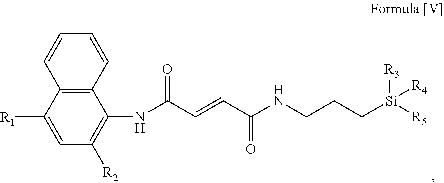
wherein R₁, R₂, R₃, R₄, and R₅ are each independently selected from the group consisting of hydrogen, an optionally substituted alkyl, an optionally substituted cycloalkyl, an optionally substituted alkoxy, a hydroxyl group, a halogen group, a nitro group, a sulfonic acid group, a sulfonate group, and a cyano group.

17: The method of claim 11, further comprising:
mixing the nanocomposite material and a solvent to form a fourth mixture;
drop casting the fourth mixture onto a surface of the substrate and drying to form the sensor having a layer of the nanocomposite material at least partially covered on the surface of the transparent substrate.

18: A mercury ion detection method, comprising:
contacting an aqueous composition containing mercury ions with the sensor of claim 1 to adsorb the mercury ions on the naphthalene modified silica nanoparticles and generate a signal corresponding to a fluorescence intensity by the sensor.

19: The method of claim 18, wherein the sensor achieves maximum fluorescence intensity when a mole ratio of naphthalene modified silica nanoparticles present on the sensor to mercury ions present in the aqueous composition is in a range of 1:5 to 1:1.

20: The method of claim 18, having a detection limit of 1 parts per billion (ppb) by weight for mercury ions, and a linearity range of 0.1 ppb to 10 parts per million (ppm) by weight.
